(19) United States
(12) Patent Application Publication
(10) Pub. No.: US 2026/0046967 A1
(43) Pub. Date: Feb. 12, 2026

(54) RADIO LINK FAILURE SIGNALING TO A SECONDARY NODE

(71) Applicant: Telefonaktiebolaget LM Ericsson (publ), Stockholm (SE)

(72) Inventors: Julien MULLER, Rennes (FR); Tahmineh TORABIAN ESFAHANI, Sollentuna (SE); Ali PARICHEHREHTEROUJENI, Linköping (SE)

(21) Appl. No.: 18/998,686

(22) PCT Filed: Aug. 8, 2023
(86) PCT No.: PCT/IB2023/058023

§ 371 Date: Jan. 27, 2025

(30) Foreign Application Priority Data
Aug. 8, 2022 (EP) 22306195.3

(51) Int. Cl. H04W 76/18; H04W 24/10

(52) U.S. Cl. CPC H04W 76/18; H04W 24/10

(57) ABSTRACT

A first network node configured to communicate wireless device(s) (WD). The WD is configured with a dual connectivity (DC) configuration including at least one parameter usable to communicate with a master node (MN) and a secondary node (SN). The first network node is configured to determine that the WD has lost connectivity with the MN, where the WD has declared a radio link failure (RLF) in the MCG, and receive an RLF Report from a third network node at which a communication re-establishment attempt was made in response to the RLF and/or a fourth network node at which the RLF Report was fetched. Upon identifying the RLF report includes information about the RLF occurring while a fast MCG recovery was configured and the SCG had an SCG status, the RLF report is forwarded to the SN including information about a fast MCG recovery failure.

### TECHNICAL FIELD

The present disclosure relates to wireless communications, and in particular, to radio link failure (RLF) signaling to a secondary node (SN).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and mobile wireless devices (WDs)(e.g., user equipment (UE)), as well as communication between network nodes and between wireless devices. Sixth Generation (6G) wireless communication systems are also under development.

### Wireless Communication Systems in 3GPP

An example wireless communication system including a radio access network 1 is illustrated in FIG. 1, where a wireless device 2 communicates with one or multiple network nodes (e.g., access nodes) 3a and 3b, which in turn are connected to a core node/core network 6. The network nodes 3a and 3b are part of the radio access network 1.

For some example wireless communication systems pursuant to 3GPP Evolved Packet System (EPS) (also referred to as LTE or 4G) standard specifications, such as specified in 3GPP TS 36.300 and related specifications, the network nodes 3a and 3b correspond typically to an Evolved NodeB (eNB) and the core node 6 corresponds typically to either a Mobility Management Entity (MME) and/or a Serving Gateway (SGW). The eNB is part of the radio access network 1, which in this case is the Evolved Universal Terrestrial Radio Access Network (E-UTRAN), while the MME and SGW are both part of the Evolved Packet Core network (EPC). The network nodes 3a and 3b (e.g., eNBs) are inter-connected via the X2 interface, and connected to EPC via the S1 interface, more specifically via S1-C to the MME and S1-U to the SGW.

For some example wireless communication systems pursuant to 3GPP 5G System, 5GS (also referred to as New Radio. NR, or 5G) standard specifications, such as specified in 3GPP TS 38.300 V17.1.0 and related specifications, on the other hand, the network nodes 3 and 4 typically correspond to an 5G NodeB (gNB) and the core node 6 typically corresponds to either an Access and Mobility Management Function (AMF) and/or a User Plane Function (UPF). The network node (e.g., gNB) is part of the radio access network 1, which in this case is the Next Generation Radio Access Network (NG-RAN), while the AMF and UPF are both part of the 5G Core Network (5GC). The network nodes (gNBs) are inter-connected via the Xn interface, and connected to 5GC via the NG interface, more specifically via NG-C to the AMF and NG-U to the UPF.

To support fast mobility between NR and LTE and avoid change of core network. LTE network nodes (e.g., eNBs) can also be connected to the 5G-CN via NG-U/NG-C and support the Xn interface. A network node (e.g., eNB) connected to 5GC is called a next generation eNB (ng-eNB) and is considered part of the NG-RAN.

### Self-Organizing Networks (SON) in 3GPP

A Self-Organizing Network (SON) is an automation technology designed to make the planning, configuration, management, optimization and healing of mobile radio access networks simpler and faster. SON functionality and behavior has been defined and specified in generally accepted mobile industry recommendations produced by organizations such as 3GPP (3rd Generation Partnership Project) and the NGMN (Next Generation Mobile Networks).

In 3GPP, the processes within the SON area are classified into either a Self-configuration process and a Self-optimization process. A self-configuration process is a process whereby newly deployed nodes are configured by automatic installation procedures to get the necessary basic configuration for system operation.

This process may work in a pre-operational state. A pre-operational state may be understood as the state from when the network node (e.g., eNB) is powered up and has backbone connectivity until the RF transmitter is switched on.

As illustrated in FIG. 2, which is a flowchart of an example Self-Configuration/Self-Optimization functionality taken from 3GPP TS 36.300 figure 22.1-1, functions handled in the pre-operational state including Basic Setup and Initial Radio Configuration are covered by the Self Configuration process.

A self-optimization process is defined as a process where wireless device (e.g., UE) and access node measurements and performance measurements are used to auto-tune the network.

This process works in an operational state. Operational state may be understood as the state where the RF interface is additionally switched on (i.e., compared to the pre-operational state).

As show in FIG. 2, functions handled in the operational state including Optimization/Adaptation are covered by the Self Optimization process.

In existing LTE systems, support for Self-Configuration and Self-Optimization may be specified, for example as described in 3GPP TS 36.300 section 22.2, including features such as Dynamic configuration, Automatic Neighbor Relation (ANR), Mobility load balancing, Mobility Robustness Optimization (MRO), RACH optimization and support for energy saving.

In NR, support for Self-Configuration and Self-Optimization is specified as well, starting with Self-Configuration features such as Dynamic configuration, Automatic Neighbor Relation (ANR) in Release 15 (Rel-15), for example as described in 3GPP TS 38.300 V17.1.0 section 15. In NR Rel-16, more SON features have been specified, including Self-Optimization features such as Mobility Robustness Optimization (MRO).

### Mobility Robustness and Radio Link Failure Report

Mobility Robustness Optimization has been standardized in NR Rel 16 and enhanced in NR Rel 17 targeting to enhance the mobility procedure performance including legacy HO (e.g., in Rel-16), distributed application platforms and services (DAPS) handover (HO) and conditional HO (CHO) optimizations in Rel 17. Upon radio link failure or a handover failure, the wireless device may log and compile an RLF report including the cell identifiers (IDs) (failed cell ID, previous cell ID, re-establishment cell ID, etc.) as well as other serving cell and neighboring cell measurements and send the RLF report either to the network node (e.g., RAN node) owning the re-establishment cell or any other network node/RAN node.

An example content of the RLF report from 3GPP TS 38.331 V17.1.0 is as follows:

| RLF-Redport-r16 ::= | CHOICE { | |
|---|---|---|
| nr-RLF-Report-r16 | SEQUENCE { | |
| measResultLastServCell-r16 | MeasResultRLFNR-r16 | |
| measResultNeighCells-r16 | SEQUENCE { | |
| measResultListNR-r16 | MeasResultList2NR-r16 | OPTIONAL, |
| measResultListEUTRA-r16 | MeasResultList2EUTRA-r16 | OPTIONAL |

| | |
|---|---|
| } | OPTIONAL, |
| c-RNTI-r16 | RNTI-Value, |
| previousPCellId-r16 | CHOICE { |
| nrPreviousCell-r16 | CGI-Info-Logging-r16, |
| eutraPreviousCell-r16 | CGI-InfoEUTRALogging |

| | |
|---|---|
| } | OPTIONAL, |

| | |
|---|---|
| failedPCellId-r16 | CHOICE { |
| nrFailedPCellID-r16 | CHOICE { |
| cellGlobalID-r16 | CGI-Info-Logging-r16, |
| pci-arfcn-r16 | PCI-ARFCN-NR-r16 |

},

| | |
|---|---|
| eutraFailedPCellId-r16 | CHOICE { |
| cellGlobalID-r16 | CGI-InfoEUTRALogging, |
| pci-arfcn-r16 | PCI-ARFCN-EUTRA-r16 |

```
      }
    },
```

| | |
|---|---|
| reconnectCellId-r16 | CHOICE { |
| nrReconnectCellId-r16 | CGI-Info-Logging-r16, |
| eutraReconnectCellId-r16 | CGI-InfoEUTRALogging |

| | |
|---|---|
| } | OPTIONAL, |

| | |
|---|---|
| timeUntilReconnection-r16 | TimeUntilReconnection-r16 |

OPTIONAL,

| | |
|---|---|
| reestablishmentCellId-r16 | CGI-Info-Logging-r16 |

OPTIONAL,

| | |
|---|---|
| timeConnFailure-r16 | INTEGER (0..1023) |

OPTIONAL,

| | |
|---|---|
| timeSinceFailure-r16 | TimeSinceFailure-r16, |
| connectionFailureType-r16 | ENUMERATED {rlf, hof}, |
| rlf-Cause-r16 | ENUMERATED {t310-Expiry, randomAccessProblem, |

rlc-MaxNumRetx,

| | beamFailureRecoveryFailure, lbtFailure-r16, | |
|---|---|---|
| | bh-rlfRecoveryFailure, t312-expiry-r17, spare1}, | |
| locationInfo-r16 | LocationInfo-r16 | OPTIONAL, |

| | |
|---|---|
| noSuitableCellFound-r16 | ENUMERATED {true} |

OPTIONAL,

| | |
|---|---|
| ra-InformationCommon-r16 | RA-InformationCommon-r16 |

```
OPTIONAL,
    ...,
    [[
```

| | |
|---|---|
| csi-rsRLMConfigBitmap-v1650 | BIT STRING (SIZE (96)) |

```
OPTIONAL
    ]],
    [[
```

| | |
|---|---|
| lastHO-Type-r17 | ENUMERATED {cho, daps, spare2, spare1} |

OPTIONAL,

| | |
|---|---|
| timeConnSourceDAPS-Failure-r17 | TimeConnSourceDAPS-Failure-r17 |

OPTIONAL,

| | |
|---|---|
| timeSinceCHO-Reconfig-r17 | TimeSinceCHO-Reconfig-r17 |

OPTIONAL,

| | |
|---|---|
| choCellId-r17 | CHOICE { |
| cellGlobalId-r17 | CGI-Info-Logging-r16, |
| pci-arfcn-r17 | PCI-ARFCN-NR-r16 |

| | |
|---|---|
| } | OPTIONAL, |

| | |
|---|---|
| choCandidateCellList-r17 | ChoCandidateCellList-r17 |

```
OPTIONAL
    ]]
  },
```

| | |
|---|---|
| eutra-RLF-Report-r16 | SEQUENCE { |
| failedPCellId-EUTRA | CGI-InfoEUTRALogging, |

```
    measResult-RLF-Report-EUTRA-r16 OCTET STRING,
    ...,
    [[
    measResult-RLF-Report-EUTRA-v1690 OCTET STRING
OPTIONAL
    ]]
  }
}
```

The core node, upon receiving the report, may forward the RLF report to the network node/RAN node in which the failure occurred, for the analysis. The network node/RAN node uses a Failure Indication message to inform the other RAN node about the failure and forward the RLF report.

### Dual Connectivity

Multi-Radio Dual Connectivity (MR-DC) describes the scenario where a wireless device that is capable of connecting to multiple network nodes (e.g., access nodes/RAN nodes) utilizes the multiple resources to increase throughput, for example, as described in 3GPP TS 37.340 V17.1.0. This is a generalization of the intra-E-UTRA Dual connectivity, for example, described in 3GPP TS 36.300.

When a wireless device is in DC mode, one network node (access node/RAN node) acts as the Master node (MN) and the other network node (access node/RAN node) acts as a Secondary node (SN). The MN and SN are connected via a network interface and at least the MN is connected to the core network. Examples of MR-DC are described, e.g., in 3GPP TS 38.401. The primary cell in MN is known as primary cell (PCell) and the primary cell in SN is known as primary secondary cell (PSCell).

### Fast MCG Recovery

Fast MCG Recovery is a feature in 3GPP which uses dual connectivity to improve robustness for the wireless device. For example, the following procedure may be performed:
The wireless device is performing in Dual Connectivity (DC), served by a Master Cell Group (MCG—from MN) and a Secondary Cell Group (SCG—from SN);
In case of RLF (e.g., a coverage hole, caused by a network condition, etc.) declared in the MCG, and if the wireless device is still in coverage of the SCG, the wireless device will send an MCG Failure to the node hosting SCG (i.e., the SN);
The SN forwards the MCG Failure message to the MN; and
The MN takes action to lower wireless device interruption time (e.g., performs a HO).

### SCG Activation/Deactivation

SCG activation/deactivation is a 3GPP feature which allows the SCG to be deactivated, while being configured, to, e.g., reduce battery consumption in the wireless device. The MN or the SN can then make the decision to activate/deactivate the SCG leg at any time. If the SCG is deactivated, only the MCG leg can be used by the wireless device.

### 3GPP Rel-18 Work Item for SON

The ongoing 3GPP Rel-18 Work Item “New WID on further enhancement of data collection for SON (Self-Organising Networks)/MDT (Minimization of Drive Tests) in NR standalone and MR-DC (Multi-Radio Dual Connectivity)” may include one or more of the following objectives:
Support of data collection for SON features, including, MRO for MR-DC SCG failure scenario, and MRO enhancement for inter-system handover voice fallback;
Specification of the wireless device reporting necessary to enhance the mobility parameter tuning;
Specification of the inter-node information exchange, including possible enhancements to interface;
Support of SON/MDT enhancements for one or more of:
   MR-DC CPAC;
   Successful PScell change report;
   Successful Handover Report (e.g. inter-RAT);
   NPN;
   RACH report;
   fast MCG recovery; and
   NR-U (MRO and UL MLB).

Fast MCG recovery uses SCG connectivity to signal MCG failure (i.e., RLF in MCG) to the MN, via the Xn interface. However, at the time of failure, the SCG may be deactivated by the SN (thanks to the SCG activation/deactivation feature) when the wireless device encounters RLF in MCG and tries to signal the MCG failure via SCG radio leg or becomes suspended. Then, the wireless device cannot send the MCGFailureInformation to the SN. This may lead to fast MCG recovery failure and re-establishment procedure, and to an increased interruption time for the wireless device. Further, the failure-related information associated with the SCG may not be reported to the network, e.g., the network node, the network does not know why the wireless device could not transmit the MCGFailureInformation, and the SCG may not be able to determine or identify failure. Therefore, the network node may not be able to optimize its activation/deactivation parameters in order to ensure MCG fast recovery success.

Thus, existing systems may lack adequate failure reporting procedures for dual connectivity.

### SUMMARY

Some embodiments advantageously provide methods, systems, and apparatuses for radio link failure report signaling to a secondary node (SN).

It should be noted that some of the solutions/features described for LTE and NR in this document may also apply to LTE connected to 5GC, as well as other types of wireless networks.

This disclosure describes different methods for the SN to be informed that a Radio Link Failure (RLF) occurred in MCG, while fast MCG recovery was configured but SCG was deactivated by the network or becomes suspended. Some of these methods allow the SN to receive the RLF Report which will contain all the details needed to analyze the MCG failure for dual connectivity (DC) operation. For example, in some embodiments, one or more of the following steps may be performed:
The RLF Report is sent to SN via a new XnAP message;
The RLF Report is sent to the SN via the Failure Indication message, which may include one or more of the following enhancements:
   An initiating condition (e.g. Fast MCG Recovery Failure);
   An Information Element (JE) indicating that fast MCG recovery failed because of SCG being deactivated or suspended; and
   An IE indicating to the receiving node the SCG related failure information, e.g., SCG state.

In some embodiments, an apparatus, system, and/or method are provided for allowing the SN to receive the RLF report, including one or more of the following steps:
The RLF Report is sent from the NG-RAN node which fetched the report (e.g., at which a re-establishment attempt is made) to one or more of:
   The SN directly;
   Both the MN and the SN; and
   The MN which will forward it to the SN.

Embodiments of the present disclosure describe network signaling usable for sending the RLF Report to the SN, including one or more of:
Call flows between MN, SN and a third node (with existing or new messages) with new triggering conditions;
XnAP message(s); and
Enhancement of the existing XnAP Failure Indication message.

Some embodiments of the present disclosure provide an advantage over existing systems wherein the SN may be able to determine that the wireless device has declared RLF because the SCG was in deactivated state, e.g., while the wireless device could have performed MCG fast recovery instead. The SN may therefore be able to optimize/modify/update/adapt/etc.) its activation/deactivation parameters in order improve performance in MCG fast recovery success.

According to an aspect, a first network node configured to communicate with a wireless device (WD), a second network node, a third network node, and a fourth network node. The WD is configured with a dual connectivity (DC) configuration including at least one parameter usable to communicate with a master node (MN) and a secondary node (SN). The first network node is the MN of the DC configuration and is associated with a master cell group (MCG). The second network node is the SN of the DC configuration and is associated with a secondary cell group (SCG). The first network node is configured to determine that the WD has lost connectivity with the MN, where the WD has declared a radio link failure (RLF) in the MCG. The first network node is further configured to receive an RLF Report from one or both of the third network node at which a communication re-establishment attempt was made by the WD in response to the RLF and the fourth network node at which the RLF Report was fetched. Upon identifying the RLF report includes information about the RLF occurring while a fast MCG recovery was configured and the SCG had an SCG status, the RLF report is forwarded to the SN including information about a fast MCG recovery failure.

In some embodiments, the RLF Report is received via an Xn Application Protocol (XnAP) message.

In some other embodiments, the XnAP message includes an XnAP Failure Indication message which includes an indication indicating one or both of the RLF occurred while the fast MCG recovery was configured and the SCG status.

In some embodiments, the indication is one or more of an initiating condition associated with the fast MCG recovery failure, an information element (IE) associated with the fast MCG recovery failure, included in the RLF Report, and the SCG status at the time of the MCG recovery.

In some other embodiments, the SCG status is one or more of deactivated, suspended, and de-configured.

In some embodiments, the first network node is further configured to, upon identifying the RLF report comprises information about the RLF occurring while a fast MCG recovery was configured and the SCG status is deactivated, optimize one or both of the fast MCG recovery and a SCG deactivation process.

In some other embodiments, optimizing the one or both the fast MCG recovery and the SCG deactivation process includes one or more of preventing the SN from enabling SCG activation or SCG deactivation, optimizing SCG activation and deactivation policies, optimizing SCG addition, optimizing primary secondary cell, PSCell, change policies, informing the SN that the fast MCG recovery is configured, and disabling one or both of the SCG activation and the SCG deactivation when radio conditions are below a predetermined threshold.

In some embodiments, the first network node is further configured to configure the WD with a fast master cell group (MCG) recovery configuration usable for responding to the RLF in the MCG and configure the WD with the second network node operating as the SN to allow one or both of an SCG activation and an SCG deactivation.

In some other embodiments, the third network node is an access node configured to communicate with the WD and the first network node.

In some embodiments, the RLF occurred in a first cell of the MCG, and the first network node is further configured to receive the RLF Report from the WD via a second cell different from the first cell.

According to another aspect, a method in a first network node configured to communicate with a wireless device (WD), a second network node, a third network node, and a fourth network node. The WD is configured with a dual connectivity (DC) configuration including at least one parameter usable to communicate with a master node (MN) and a secondary node (SN). The first network node is the MN of the DC configuration and is associated with a master cell group (MCG). The second network node is the SN of the DC configuration and is associated with a secondary cell group (SCG). The method includes determining that the WD has lost connectivity with the MN. The WD has declared a radio link failure (RLF) in the MCG. The method further includes receiving an RLF Report from one or both of the third network node at which a communication re-establishment attempt was made by the WD in response to the RLF and the fourth network node at which the RLF Report was fetched. Upon identifying the RLF report comprises information about the RLF occurring while a fast MCG recovery was configured and the SCG had an SCG status, the RLF report is forwarded to the SN including information about a fast MCG recovery failure.

In some other embodiments, the XnAP message includes an XnAP Failure Indication message which includes an indication indicating one or both of the RLF occurred while the fast MCG recovery was configured and the SCG status.

In some embodiments, the indication is one or more of an initiating condition associated with the fast MCG recovery failure, an information element (IE) associated with the fast MCG recovery failure, included in the RLF Report, and the SCG status at the time of the MCG recovery.

In some other embodiments, the SCG status is one or more of deactivated, suspended, and de-configured.

In some embodiments, the method further includes, upon identifying the RLF report comprises information about the RLF occurring while a fast MCG recovery was configured and the SCG status is deactivated, optimizing one or both of the fast MCG recovery and a SCG deactivation process.

In some other embodiments, optimizing the one or both the fast MCG recovery and the SCG deactivation process includes one or more of preventing the SN from enabling SCG activation or SCG deactivation, optimizing SCG activation and deactivation policies, optimizing SCG addition, optimizing primary secondary cell. PSCell, change policies, informing the SN that the fast MCG recovery is configured, and disabling one or both of the SCG activation and the SCG deactivation when radio conditions are below a predetermined threshold.

In some embodiments, the method further includes configuring the WD with an MCG recovery configuration usable for responding to the RLF in the MCG and configuring the WD with the second network node operating as the SN to allow one or both of an SCG activation and an SCG deactivation.

In some other embodiments, the third network node is an access node configured to communicate with the WD and the first network node.

In some embodiments, the RLF occurred in a first cell of the MCG, and the method further includes receiving the RLF Report from the WD via a second cell different from the first cell.

According to an aspect, a second network node configured to communicate with a wireless device (WD), a first network node, and a third network node. The WD is configured with a dual connectivity (DC) configuration including at least one parameter usable to communicate with a master node (MN) and a secondary node (SN). The first network node is the MN of the DC configuration and is associated with a master cell group (MCG). The second network node is the SN of the DC configuration and is associated with a secondary cell group (SCG). The second network node is configured to receive a radio link failure (RLF) Report from one or both of the first network node, where the WD has lost connectivity with the first network node and declared the RLF in the MCG, and the third network node at which a communication re-establishment attempt was made by the WD in response to the RLF. The RLF report includes information about a fast MCG recovery failure. Upon identifying the RLF report comprises information about the RLF occurring while a fast MCG recovery was configured and the SCG had an SCG status, an SCG process is optimized.

In some embodiments, the RLF Report is received via an Xn Application Protocol (XnAP) message.

In some other embodiments, the XnAP message includes an XnAP Failure Indication message which includes an indication indicating one or both of the RLF occurred while the fast MCG recovery was configured and the SCG status.

In some embodiments, the indication is one or more of an initiating condition associated with the fast MCG recovery failure, an information element (IE) associated with the fast MCG recovery failure, included in the RLF Report, and the SCG status at the time of the MCG recovery.

In some other embodiments, the SCG status is one or more of deactivated, suspended, and de-configured.

In some embodiments, optimizing the SCG process includes disabling one or both of an SCG activation and an SCG deactivation associated with the WD and other WDs sharing one or more conditions.

In some other embodiments, optimizing the SCG process includes deactivating the SCG for a reduced period of time for WDs sharing the one or more conditions.

In some embodiments, the second network node is further configured to receive, from the first network node, a configuration to allow one or both of a SCG activation and a SCG deactivation.

In some other embodiments, the second network node is further configured to deactivate the SCG based on one or more traffic parameters.

In some embodiments, the third network node is an access node configured to communicate with the WD and the second network node.

According to another aspect, a method in a second network node configured to communicate with a wireless device (WD), a first network node, and a third network node. The WD is configured with a dual connectivity (DC) configuration including at least one parameter usable to communicate with a master node (MN) and a secondary node (SN). The first network node is the MN of the DC configuration and is associated with a master cell group (MCG). The second network node is the SN of the DC configuration and is associated with a secondary cell group (SCG). The method includes receiving a radio link failure, RLF, Report from one or both of the first network node, where the WD has lost connectivity with the first network node and declared the RLF in the MCG, and the third network node at which a communication re-establishment attempt was made by the WD in response to the RLF. The RLF report includes information about a fast MCG recovery failure. Upon identifying the RLF report comprises information about the RLF occurring while a fast MCG recovery was configured and the SCG had an SCG status, an SCG process is optimized.

In some embodiments, the RLF Report is received via an Xn Application Protocol (XnAP) message.

In some other embodiments, the XnAP message includes an XnAP Failure Indication message which includes an indication indicating one or both of the RLF occurred while the fast MCG recovery was configured and the SCG status.

In some embodiments, the indication is one or more of an initiating condition associated with the fast MCG recovery failure, an information element (IE) associated with the fast MCG recovery failure, included in the RLF Report, and the SCG status at the time of the MCG recovery.

In some other embodiments, the SCG status is one or more of deactivated, suspended, and de-configured.

In some embodiments, optimizing the SCG process includes disabling one or both of an SCG activation and an SCG deactivation associated with the WD and other WDs sharing one or more conditions.

In some other embodiments, optimizing the SCG process includes deactivating the SCG for a reduced period of time for WDs sharing the one or more conditions.

In some embodiments, the method further includes receiving, from the first network node, a configuration to allow one or both of a SCG activation and a SCG deactivation.

In some other embodiments, the method further includes deactivating the SCG based on one or more traffic parameters.

In some embodiments, the third network node is an access node configured to communicate with the WD and the second network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture in which a wireless device communicates with one or more multiple access nodes, which in turn is connected to a network node;

FIG. 2 is a flowchart illustrating an example self-configuration/self-optimization functionality;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node, such as a network node serving as an MN for a wireless device, for RLF report signaling to a SN according to some embodiments of the present disclosure;

FIG. 10 is a flowchart of another example process in a network node, such as a network node serving as a SN for a wireless device, for RLF report signaling to a SN according to some embodiments of the present disclosure;

FIG. 11 is a flowchart of another example process in a network node, such as a network node serving as a SN for a wireless device, for RLF report signaling to a SN according to some embodiments of the present disclosure;

FIG. 12 is a flowchart of another example process in a network node, such as a network node which is neither a MN nor a SN for a wireless device, for RLF report signaling to a SN according to some embodiments of the present disclosure;

FIG. 13 is a flowchart of an example process in a wireless device for RLF report signaling to a SN according to some embodiments of the present disclosure;

FIG. 14 is a flowchart of another example process in a network node, such as a network node serving as an MN, according to some embodiments of the present disclosure; and

FIG. 15 is a flowchart of another example process in a network node, such as a network node serving as a SN according to some embodiments of the present disclosure.

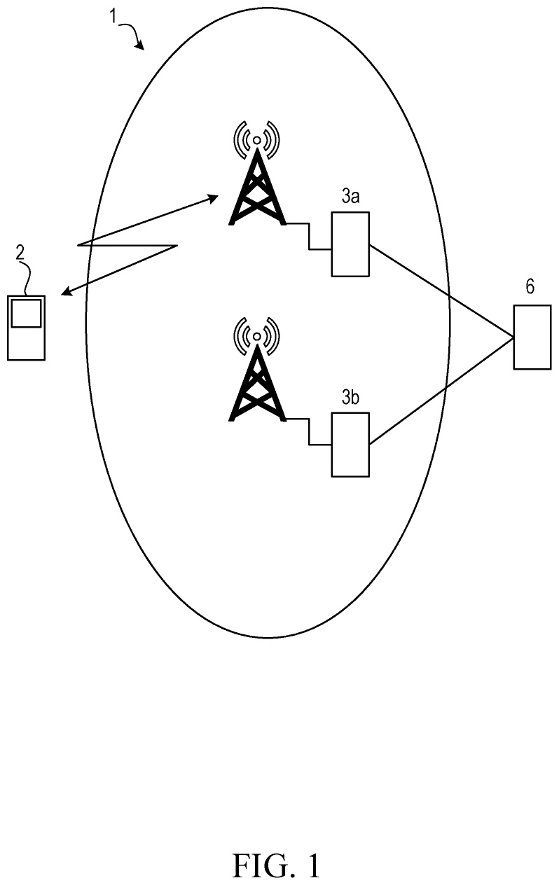

### DETAILED DESCRIPTION

Before describing in detail example embodiments, it is noted that the embodiments reside primarily in combinations of apparatus components and processing steps related to radio link failure report signaling to a SN. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

In this disclosure, when the term LTE is used without further qualification/specification, it may be used to refer to LTE-EPC.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”. “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The network node may be a master node (MN) or a secondary node (SN). The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME). USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller. RNC, evolved Node B (eNB). Node B, gNB, Multi-cell/multicast Coordination Entity (MCE). IAB node, relay node, access point, radio access point. Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax). Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide improved RLF Report signaling to a SN over existing wireless communication systems/networks, such as 3GPP 4G and/or 5G systems/networks.

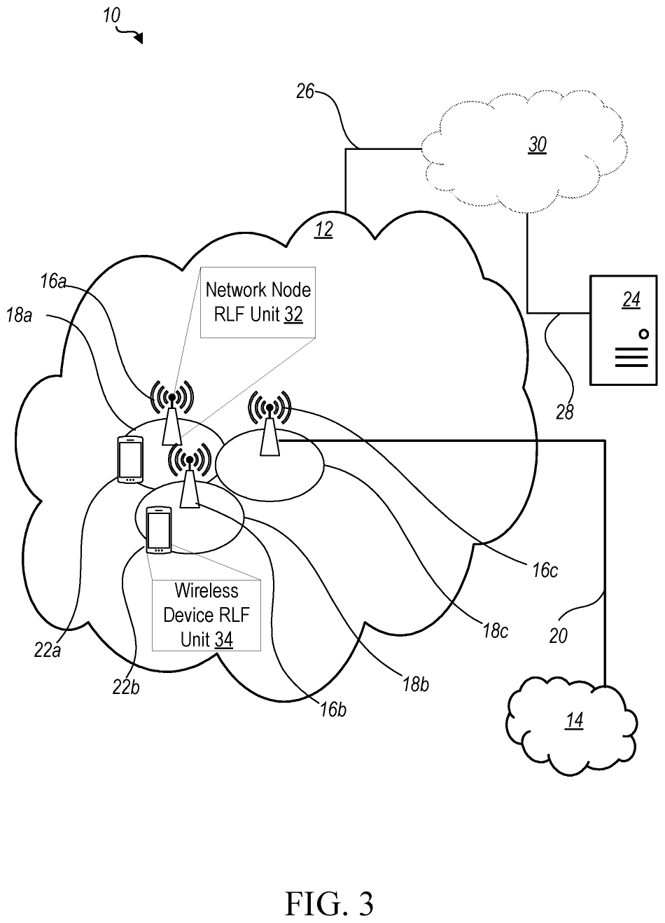

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b. 16c (referred to collectively as network nodes 16), such as NBs, eNBs, gNBs or other types of wireless access points, each defining a corresponding coverage area 18a, 18b. 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a. 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a Network Node RLF Unit 32 which is configured for RLF report signaling to a SN. A wireless device 22 is configured to include a Wireless Device RLF Unit 34 which is configured for RLF report signaling to a SN.

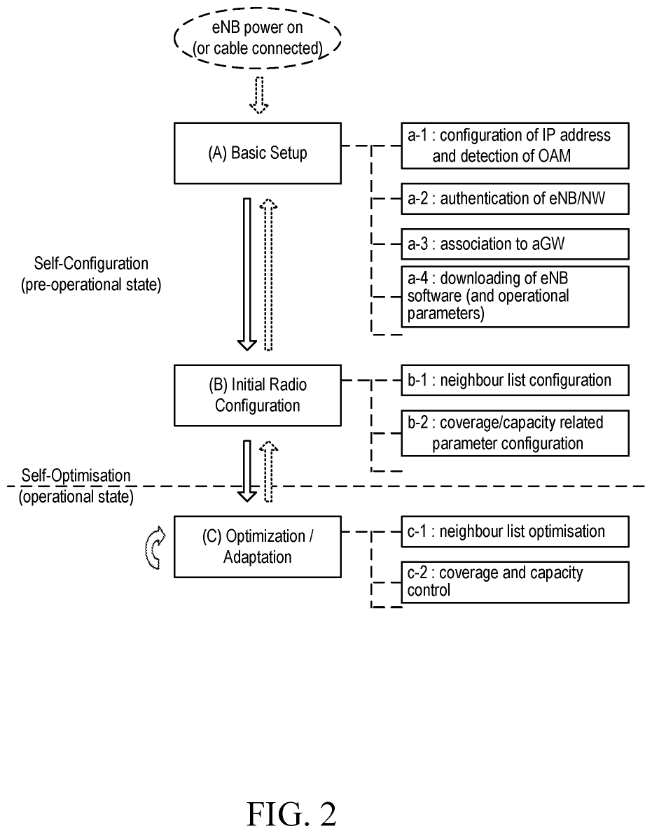

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a configuration unit 54 configured to enable the service provider to observe/monitor/control/transmit to/receive from/etc. the network node 16 and or the wireless device 22.

The communication system 10 further includes a network node 16 provided in a communication system 10 and including hardware 58 enabling it to communicate with the host computer 24, and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory. e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed. e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include Network Node RLF Unit 32 configured for RLF report signaling to a SN.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed. e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a Wireless Device RLF Unit 34 configured for RLF report signaling to a SN.

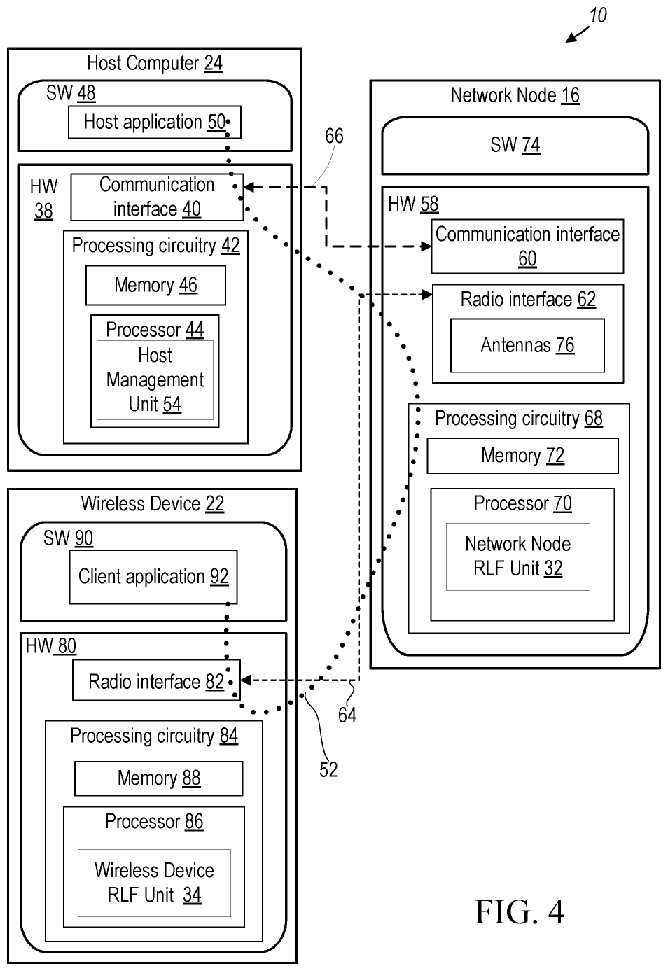

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as Network Node RLF Unit 32, Wireless Device RLF Unit 34, as being within a respective processor, it is contemplated that these units may be implemented such that a portion of the unit is stored in a corresponding memory within the processing circuitry. In other words, the units may be implemented in hardware or in a combination of hardware and software within the processing circuitry.

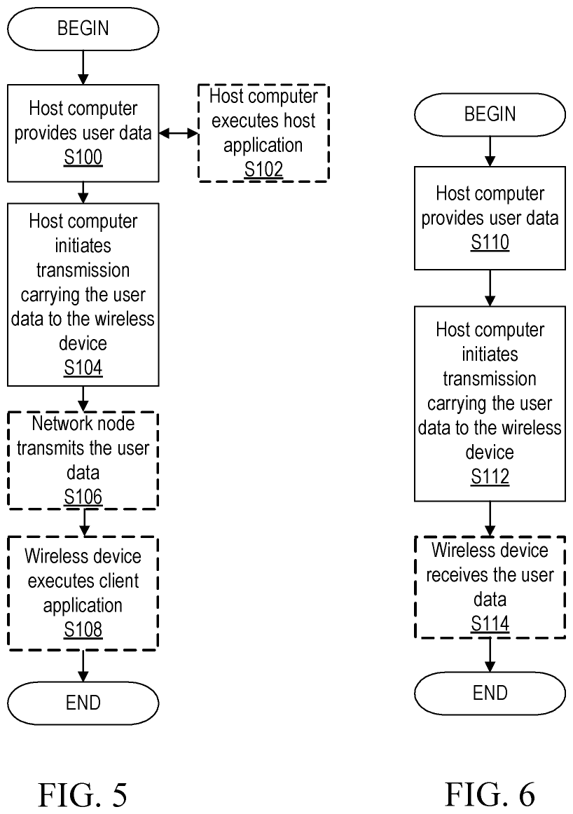

FIG. 5 is a flowchart illustrating an example method implemented in a communication system, such as, for example, the communication system of FIGS. 3 and 4, in accordance with one embodiment. The communication system may include a host computer 24, a network node 16, and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

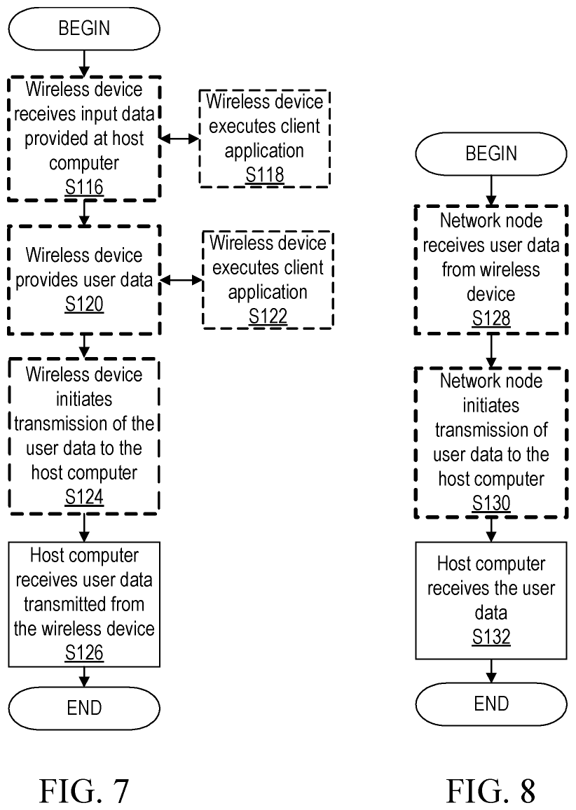

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

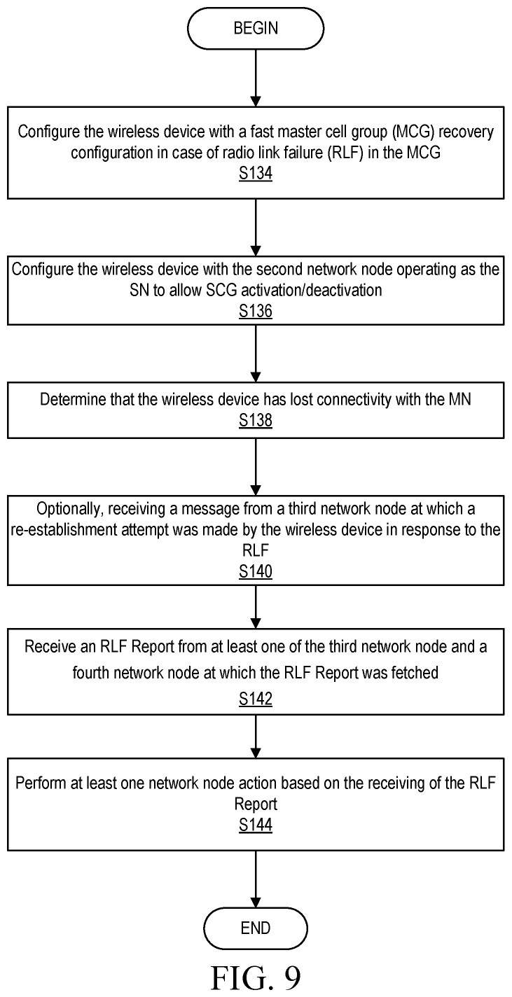

FIG. 9 is a flowchart of an example process in a network node 16 for radio link failure report signaling to a SN. One or more blocks described herein may be performed by one or more elements of network node 16 such as by one or more of processing circuitry 68 (including the Network Node RLF Unit 32), processor 70, radio interface 62 and/or communication interface 60. The network node 16 may be configured to communicate with a wireless device 22 and a second network node 16, where the wireless device 22 is configured with a dual connectivity (DC) configuration including a master node (MN) and a secondary node (SN), the first network node 16 is the MN of the DC configuration, and the second network node 16 is the SN of the DC configuration. Network node 16 is configured to configure (Block S134) the wireless device 22 with a fast master cell group (MCG) recovery configuration in case of radio link failure (RLF) in the MCG. The network node 16 is further configured to configure (Block S136) the wireless device 22 with the second network node 16 operating as the SN to allow SCG activation/deactivation. The network node 16 is further configured to determine (Block S138) that the wireless device 22 has lost connectivity with the MN. The network node 16 is configured to optionally, receive (Block S140) a message from a third network node 16 at which a re-establishment attempt was made by the wireless device 22 in response to the RLF. The network node 16 is configured to receive (Block S142) an RLF Report from at least one of the third network node 16, and a fourth network node 16 at which the RLF Report was fetched. The network node 16 is configured to perform (Block S144) at least one network node action based on the receiving of the RLF Report.

In some embodiments, the RLF Report is received via at least one Xn Application Protocol (XnAP) message. In some embodiments, the at least one XnAP message includes an XnAP Failure Indication message, the XnAP Failure Indication message indicating that the RLF occurred while fast MCG recovery was configured and that the SCG was at least one of deactivated, suspended, and/or de-configured. Optionally, the indication is at least one of an initiating condition, an information element (IE), included in the RLF Report, and an SCG status at the time of the MCG recovery. In some embodiments, the performing of the at least one network node action includes forward the RLF Report to the second network node 16 based on identifying that the RLF defined in the received RLF Report occurred while fast MCG recovery was configured and while the SCG was at least one of deactivated, suspended, and de-configured. In some embodiments, the performing of the at least one network node action includes optimizing and/or modifying the combination of Fast MCG recovery and SCG deactivation features based on a determination that the RLF defined in the received RLF Report occurred while fast MCG recovery was configured and while SCG was deactivated. The optimizing and/or modifying including at least one of prohibiting the SN from enabling the SCG activation/deactivation, optimizing/modifying/updating/adapting the SCG activation/deactivation criterion and/or policies (e.g., for improved performance, such as reducing a failure rate), optimizing the SCG addition/Primary Secondary Cell (PSCell) change policies, informing the SN that fast MCG is configured, and disabling SCG activation/deactivation, e.g., when radio conditions are getting worse/deteriorating (e.g., increased interference metrics, decreased speed/throughput metrics, worsening channel condition metrics, etc.).

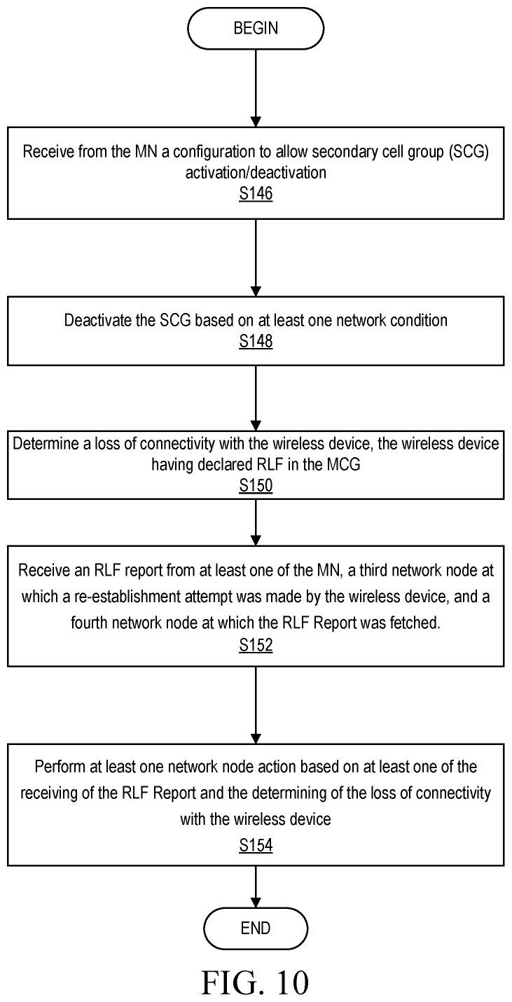

FIG. 10 is a flowchart of another example process in a network node 16 for radio link failure report signaling to a SN. One or more blocks described herein may be performed by one or more elements of network node 16 such as by one or more of processing circuitry 68 (including the Network Node RLF Unit 32), processor 70, radio interface 62 and/or communication interface 60. The network node 16 may be in communication with a wireless device 22 being configured with a dual connectivity (DC) configuration including a master node (MN) and a secondary node (SN), where the first network node 16 is the MN of the DC configuration, and the second network node 16 is the SN of the DC configuration. Network node 16 is configured to receive (Block S146) from the MN a configuration to allow secondary cell group (SCG) activation/deactivation. Network node 16 is configured to deactivate (Block S148) the SCG based on at least one network condition Network node 16 is configured to determine (Block S150) a loss of connectivity with the wireless device 22, the wireless device 22 having declared RLF in the MCG. Network node 16 is configured to receive (Block S152) an RLF report from at least one of the MN, a third network node 16 at which a re-establishment attempt was made by the wireless device 22, and a fourth network node 16 at which the RLF Report was fetched. Network node 16 is configured to perform (Block S154) at least one network node action based on at least one of the receiving of the RLF Report and the determining of the loss of connectivity with the wireless device 22.

In some embodiments, the wireless device 22 is configured with a fast master cell group (MCG) recovery configuration in case of radio link failure (RLF) in the MCG. In some embodiments, the RLF Report is received via at least one Xn Application Protocol (XnAP) message. In some embodiments, the at least one XnAP message includes an XnAP Failure Indication message, the XnAP Failure Indication message indicating that the RLF occurred while fast MCG recovery was configured and the SCG was deactivated. Optionally, the indication is at least one of an initiating condition, an information element (IE), and included in the RLF Report. In some embodiments, the performing of the at least one network node action includes optimizing and/or modifying the SCG deactivation feature based on determining that the RLF defined in the received RLF Report occurred while fast MCG recovery was configured and while SCG was deactivated. The optimizing and/or modifying includes at least one of disabling SCG activation/deactivation for wireless devices 22 in similar network conditions, and deactivating SCG for shorter periods (e.g., as compared to previously configured periods) for wireless devices 22 in similar network conditions.

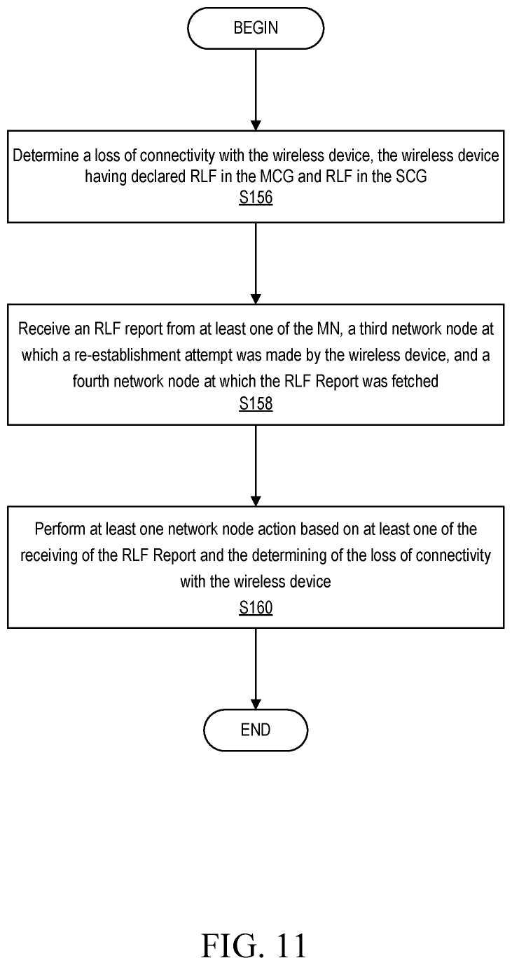

FIG. 11 is a flowchart of another example process in a network node 16 for radio link failure report signaling to a SN. One or more blocks described herein may be performed by one or more elements of network node 16 such as by one or more of processing circuitry 68 (including the Network Node RLF Unit 32), processor 70, radio interface 62 and/or communication interface 60. The network node 16 may be configured to communicate with a wireless device 22 and a first network node 16, where the wireless device 22 is configured with a dual connectivity (DC) configuration including a master node (MN) and a secondary node (SN), the first network node 16 is the MN of the DC configuration, a second network node 16 is the SN of the DC configuration. Network node 16 is configured to determine (Block S156) a loss of connectivity with the wireless device 22, where the wireless device 22 has declared RLF in the MCG and RLF in the SCG. Network node 16 is further configured to receive (Block S158) an RLF report from at least one of the MN, a third network node 16 at which a re-establishment attempt was made by the wireless device 22, and a fourth network node 16 at which the RLF Report was fetched. Network node 16 is further configured to perform (Block S160) at least one network node action based on at least one of the receiving of the RLF Report and the determining of the loss of connectivity with the wireless device 22.

In some embodiments, the wireless device 22 is configured with a fast master cell group (MCG) recovery configuration in case of radio link failure (RLF) in the MCG. In some embodiments, the RLF Report is received via at least one Xn Application Protocol (XnAP) message. In some embodiments, the at least one XnAP message includes an XnAP Failure Indication message. The XnAP Failure Indication message indicates that the RLF occurred while fast MCG recovery was configured and the SCG was deactivated. Optionally, the indication is at least one of an initiating condition, an information element (IE), included in the RLF Report, and an SCG status at the time of the MCG recovery. In some embodiments, the performing of the at least one network node action includes optimizing and/or modifying the SCG deactivation feature based on determining that the RLF defined in the received RLF Report occurred while fast MCG recovery was configured and while SCG was deactivated. The optimizing and/or modifying includes at least one of disabling SCG activation/deactivation for wireless devices 22 in similar network conditions, and deactivating SCG for shorter periods for wireless devices 22 in similar network conditions.

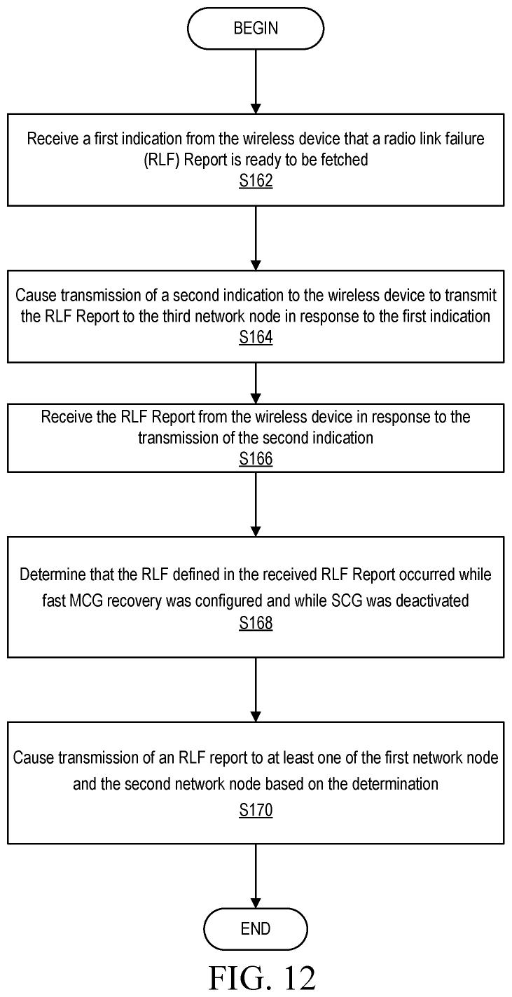

FIG. 12 is a flowchart of another example process in a network node 16 for radio link failure report signaling to a SN. One or more blocks described herein may be performed by one or more elements of network node 16 such as by one or more of processing circuitry 68 (including the Network Node RLF Unit 32), processor 70, radio interface 62 and/or communication interface 60. Network node 16 may be configured to communicate with a wireless device 22 in a wireless communication network including a first network node 16 and a second network node 16, where the wireless device 22 is configured with a dual connectivity (DC) configuration including a master node (MN) and a secondary node (SN), the first network node 16 is the MN of the DC configuration, and the second network node 16 is the SN of the DC configuration. Network node 16 (e.g., a network node 16 in the wireless communication network which is not the MN or the SN of the wireless device 22) is configured to receive (Block S162) a first indication from the wireless device 22 that a radio link failure (RLF) Report is ready to be fetched. Network node 16 is configured to cause transmission (Block S164) of a second indication to the wireless device 22 to transmit the RLF Report to the third network node 16 in response to the first indication. Network node 16 is configured to receive (Block S166) the RLF Report from the wireless device 22 in response to the transmission of the second indication. Network node 16 is configured to determine (Block S168) that the RLF defined in the received RLF Report occurred while fast MCG recovery was configured and while SCG was deactivated. Network node 16 is configured to cause transmission (Block S170) of an RLF report to at least one of the first network node 16 and the second network node 16 based on the determination.

In some embodiments, the wireless device 22 is configured with a fast master cell group (MCG) recovery configuration in case of radio link failure (RLF) in the MCG. In some embodiments, the RLF Report is received via at least one Xn Application Protocol (XnAP) message. In some embodiments, the at least one XnAP message includes an XnAP Failure Indication message. The XnAP Failure Indication message indicates that the RLF occurred while fast MCG recovery was configured, and the SCG was deactivated. Optionally, the indication is at least one of an initiating condition, an information element (IE), and included in the RLF Report. In some embodiments, the network node 16 is further configured to determine that the wireless device 22 has made a re-establishment attempt with the third network node 16. The network node 16 is configured to cause transmission of the RLF report to the at least one of the first network node 16 and the second network node 16 based on the determination that the wireless device 22 has made the re-establishment attempt.

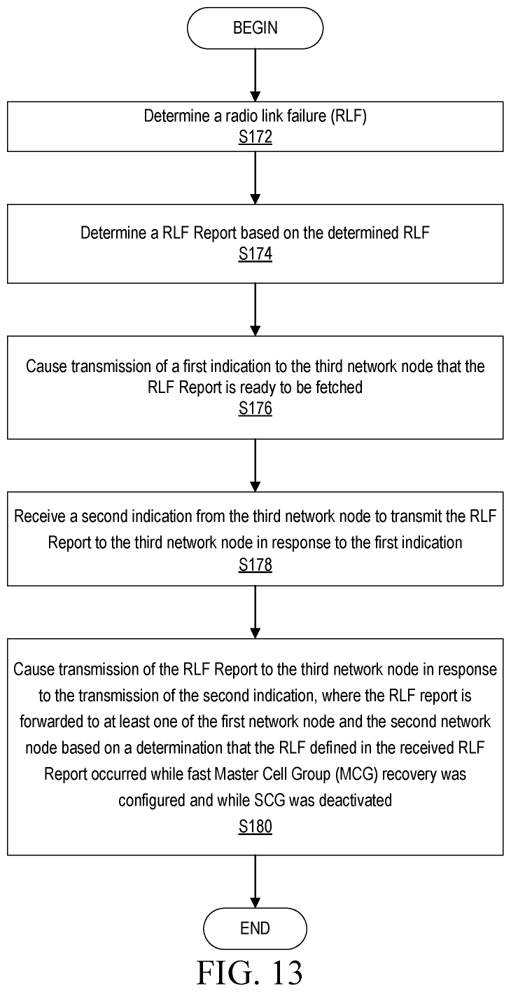

FIG. 13 is a flowchart of an example process in a wireless device 22 according to some embodiments of the present disclosure for radio link failure report signaling to a SN. One or more blocks described herein may be performed by one or more elements of wireless device 22 such as by one or more of processing circuitry 84 (including the Wireless Device RLF Unit 34), processor 86, radio interface 82 and/or communication interface 60. Wireless device 22 may be configured to communicate with a first network node 16 in a wireless communication network including a second network node 16 and a third network node 16, where the wireless device 22 is configured with a dual connectivity (DC) configuration including a master node (MN) and a secondary node (SN), the first network node 16 is the MN of the DC configuration, and the second network node 16 is the SN of the DC configuration. The wireless device 22 is configured to determine (Block S172) a radio link failure (RLF). Wireless device 22 is configured to determine (Block S174) an RLF Report based on the determined RLF. Wireless device 22 is configured to cause transmission (Block S176) of a first indication to the third network node 16 that the RLF Report is ready to be fetched. Wireless device 22 is configured to receive (Block S178) a second indication from the third network node 16 to transmit the RLF Report to the third network node 16 in response to the first indication. Wireless device 22 is configured to cause transmission (Block S180) of the RLF Report to the third network node 16 in response to the transmission of the second indication, where the RLF report is forwarded to at least one of the first network node 16 and the second network node 16 based on a determination that the RLF defined in the received RLF Report occurred while fast Master Cell Group (MCG) recovery was configured and while SCG was deactivated.

In some embodiments, the wireless device 22 is further configured to perform a re-establishment attempt with the third network node 16, where the forwarding of the RLF report to the at least one of the first network node 16 and the second network node 16 is based on the wireless device 22 performing the re-establishment attempt.

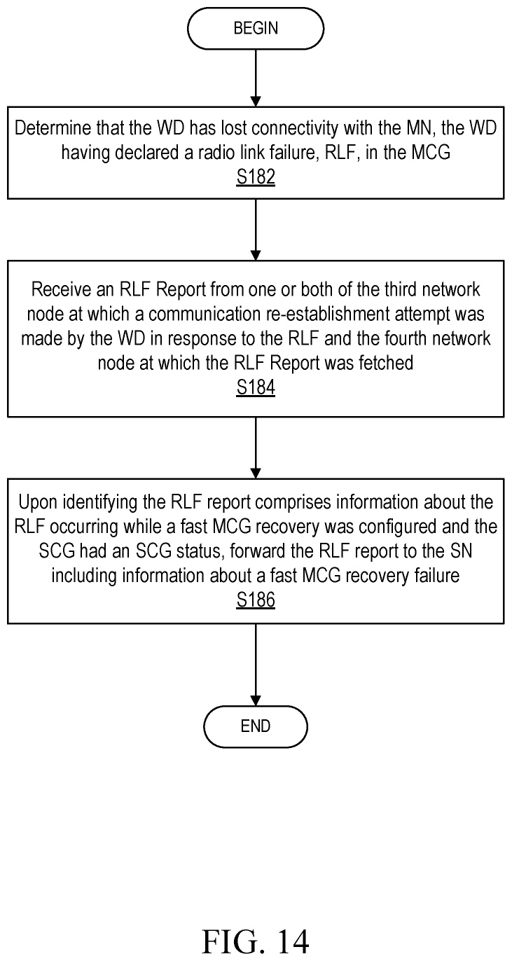

FIG. 14 is a flowchart of another example process in a first network node 16a, such as a network node 16 serving as an MN. One or more blocks described herein may be performed by one or more elements of network node 16 such as by one or more of processing circuitry 68 (including the Network Node RLF Unit 32), processor 70, radio interface 62 and/or communication interface 60. The first network node 16a is configured to communicate with a WD 22, a second network node 16b, a third network node 16c, and a fourth network node 16d. The WD 22 is configured with a dual connectivity (DC) configuration including at least one parameter usable to communicate with a master node (MN) and a secondary node (SN). The first network node 16a is the MN of the DC configuration and is associated with a master cell group (MCG). The second network node 16b is the SN of the DC configuration and is associated with a secondary cell group (SCG). The first network node 16a is configured to determine (Block S182) that the WD has lost connectivity with the MN. The WD 22 has declared a radio link failure (RLF) in the MCG. Further, the first network node 16a is configured to receive (Block S184) an RLF Report from one or both of the third network node 16c at which a communication re-establishment attempt was made by the WD 22 in response to the RLF and the fourth network node 16d at which the RLF Report was fetched. In addition, the first network node 16a is configured to, upon identifying the RLF report comprises information about the RLF occurring while a fast MCG recovery was configured and the SCG had an SCG status, forward (Block S186) the RLF report to the SN including information about a fast MCG recovery failure.

In some other embodiments, the XnAP message includes an XnAP Failure Indication message which includes an indication indicating one or both of the RLF occurred while the fast MCG recovery was configured and the SCG status.

In some embodiments, the indication is one or more of an initiating condition associated with the fast MCG recovery failure, an information element (IE) associated with the fast MCG recovery failure, included in the RLF Report, and the SCG status at the time of the MCG recovery.

In some other embodiments, the SCG status is one or more of deactivated, suspended, and de-configured.

In some embodiments, the method further includes, upon identifying the RLF report comprises information about the RLF occurring while a fast MCG recovery was configured and the SCG status is deactivated, optimizing one or both of the fast MCG recovery and a SCG deactivation process.

In some other embodiments, optimizing the one or both the fast MCG recovery and the SCG deactivation process includes one or more of preventing the SN from enabling SCG activation or SCG deactivation, optimizing SCG activation and deactivation policies, optimizing SCG addition, optimizing primary secondary cell, PSCell, change policies, informing the SN that the fast MCG recovery is configured, and disabling one or both of the SCG activation and the SCG deactivation when radio conditions are below a predetermined threshold.

In some embodiments, the method further includes configuring the WD 22 with an MCG recovery configuration usable for responding to the RLF in the MCG and configuring the WD 22 with the second network node 16b operating as the SN to allow one or both of an SCG activation and an SCG deactivation.

In some other embodiments, the third network node 16c is an access node configured to communicate with the WD 22 and the first network node 16a.

In some embodiments, the RLF occurred in a first cell of the MCG, and the method further includes receiving the RLF Report from the WD 22 via a second cell different from the first cell.

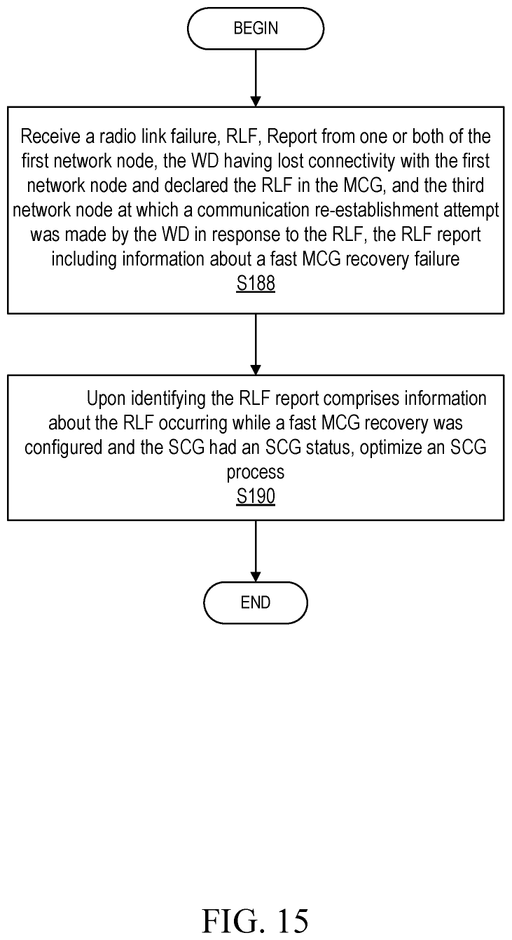

FIG. 15 is a flowchart of another example process in a second network node, such as a network node serving as a SN. One or more blocks described herein may be performed by one or more elements of network node 16 such as by one or more of processing circuitry 68 (including the Network Node RLF Unit 32), processor 70, radio interface 62 and/or communication interface 60. The second network node 16 is configured to communicate with a WD 22, a first network node 16a, and a third network node 16c. The WD 22 is configured with a dual connectivity (DC) configuration including at least one parameter usable to communicate with a master node (MN) and a secondary node (SN). The first network node is the MN of the DC configuration and is associated with a master cell group (MCG). The second network node is the SN of the DC configuration and is associated with a secondary cell group (SCG). The second network node 16b is configured to receive (Block S188) a radio link failure (RLF) Report from one or both of the first network node 16a, where the WD 22 has lost connectivity with the first network node 16a and declared the RLF in the MCG, and the third network node 16c at which a communication re-establishment attempt was made by the WD 22 in response to the RLF. The RLF report includes information about a fast MCG recovery failure. Further, the second network node 16b is configured to, upon identifying the RLF report comprises information about the RLF occurring while a fast MCG recovery was configured and the SCG had an SCG status, optimize (Block S190) an SCG process.

In some embodiments, the RLF Report is received via an Xn Application Protocol (XnAP) message.

In some other embodiments, the XnAP message includes an XnAP Failure Indication message which includes an indication indicating one or both of the RLF occurred while the fast MCG recovery was configured and the SCG status.

In some embodiments, the indication is one or more of an initiating condition associated with the fast MCG recovery failure, an information element (IE) associated with the fast MCG recovery failure, included in the RLF Report, and the SCG status at the time of the MCG recovery.

In some other embodiments, the SCG status is one or more of deactivated, suspended, and de-configured.

In some embodiments, optimizing the SCG process includes disabling one or both of an SCG activation and an SCG deactivation associated with the WD 22 and other WDs 22 sharing one or more conditions.

In some other embodiments, optimizing the SCG process includes deactivating the SCG for a reduced period of time for WDs 22 sharing the one or more conditions.

In some embodiments, the method further includes receiving, from the first network node 16a, a configuration to allow one or both of a SCG activation and a SCG deactivation.

In some other embodiments, the method further includes deactivating the SCG based on one or more traffic parameters.

In some embodiments, the third network node 16c is an access node configured to communicate with the WD 22 and the second network node 16b.

Having described the general process flow of arrangements of the disclosure and having provided examples of hardware and software arrangements for implementing the processes and functions of the disclosure, the sections below provide details and examples of arrangements for radio link failure (RLF) signaling to a secondary node (SN).

As used herein, “network nodes 16” and “RAN nodes” may be used interchangeably. Furthermore, the terms MN and SN may be different depending on which wireless device 22 perspective is under consideration, i.e., the same network node 16 can act as MN and SN simultaneously for a wireless device 22 or for different wireless devices 22.

Some embodiments of the present disclosure provide a first network node 16 acting as a MN for a wireless device 22, and a method for operating the first network node 16. The wireless device 22 is configured (e.g., by first network node 16 and/or a second network node 16 and/or a host computer 24) to perform fast MCG recovery, e.g., in case of RLF in the MCG associated with the MN, and a second network node 16 is configured (e.g., by first network node 16 and/or another network node 16 and/or host computer 24) to operate as a SN for wireless device 22. e.g., to allow for SCG activation/deactivation. If the wireless device 22 loses connectivity with the first network node 16 (acting as the MN with respect to wireless device 22), the wireless device 22 may declare RLF. Optionally, the wireless device 22 may attempt to re-establish a connection with a third network node 16. The first network node 16 optionally receives a message from the third network node 16 (e.g., via a direct communication and/or via core network 14), the message including a request for a wireless device 22 context information (e.g., “UE Context”). The first network node 16 may receive an RLF Report from the third network node 16 and/or from a fourth network node 16, e.g., at which the RLF Report was fetched.

In some embodiments of the present disclosure, the RLF Report is received (e.g., by the first network node 16) via an XnAP message.

In some embodiments, the RLF Report may be contained in a XnAP Failure Indication message, where the message indicates that the RLF occurred while fast MCG recovery was configured, but that SCG was deactivated/suspended/de-configured at that time. In some embodiments, this indication may be one or more of:
An initiating condition, e.g., Fast MCG Recovery Failure;
An information element (IE), e.g., Fast MCG Recovery Failure;
Included in the RLF Report itself; and/or
SCG status at the time of the MCG recovery, e.g., SCG deactivated/SCG suspended/SCG de-configured prior failure.

In some embodiments, upon identifying that the RLF defined in the received RLF Report occurred while fast MCG recovery was configured and while SCG was deactivated/suspended/de-configured, the RLF Report is forwarded to the second network node 16.

In some embodiments, upon identifying that the RLF defined in the received RLF Report occurred while fast MCG recovery was configured and while SCG was deactivated, the combination of Fast MCG recovery and SCG deactivation features maybe optimized by, for example, one or more of:
Not allowing the SN to enable SCG activation/deactivation;
Optimizing SCG activation/deactivation criterion/policies;
Optimizing SCG addition/PSCell change policies;
Informing the SN that Fast MCG is configured; and/or
Disabling SCG activation/deactivation when radio conditions are getting worse.

In some embodiments, a method performed at the second network node 16 operating as SN is provided, where the includes receiving (e.g., at the second network node 16) from the first network node 16 a configuration which enables SCG activation/deactivation. The method further includes deactivating the SCG, e.g., because of lack of traffic. If connectivity with the wireless device 22 is lost, the wireless device 22 declares RLF in the MCG (e.g., of the first network node 16). An RLF Report is received (e.g., at the second network node 16) from at least one of the first network node 16, a third network node 16 at which a re-establishment attempt is made by the wireless device 22, and/or or a fourth network node 16 at which the RLF Report was fetched.

In some embodiments, the RLF Report may be received via a XnAP message.

In some embodiments, the RLF Report may be contained in an XnAP Failure Indication message, where the message indicates that the RLF occurred while fast MCG recovery was configured but SCG was deactivated. This indication may further be at least one of:
An initiating condition, e.g., Fast MCG Recovery Failure;
An IE, e.g., Fast MCG Recovery Failure; and/or
Included in the RLF Report itself.

In some embodiments, upon identifying that the RLF defined in the received RLF Report occurred while fast MCG recovery was configured and while SCG was deactivated, the method further includes optimizing the SCG deactivation feature by, e.g., one or more of:
Disabling SCG activation/deactivation for wireless device 22 in the same/similar conditions (e.g., coverage (area), location if available, etc.)
Deactivating SCG for shorter periods for UEs in same conditions (e.g., coverage (area), location if available, etc.).

In some embodiments, a method performed at a second network node 16 operating as an SN is provided. The method includes detecting/determining that the wireless device 22 has lost connectivity, e.g., has declared RLF in MCG (associated with the MN/first network node 16). The method further includes detecting/determining that the wireless device 22 has lost connectivity. e.g., has declared RLF in the SCG (associated with the SN/second network node 16). The method further includes receiving an RLF Report from at least one of the first network node 16, a third network node 16 at which a re-establishment attempt is made by the wireless device 22, and/or a fourth network node 16 at which the RLF Report was fetched.

In some embodiments, the RLF Report is received (e.g., at the second network node 16) via an XnAP message.

In some embodiments, the RLF Report is included in an XnAP Failure Indication message, where the message indicates that the RLF occurred while fast MCG recovery was configured but SCG was deactivated. This indication may include one or more of:
An initiating condition, e.g., Fast MCG Recovery Failure;
An IE, e.g., Fast MCG Recovery Failure;
Included in the RLF Report itself; and/or
SCG status at the time of the MCG recovery, e.g., SCG deactivated/SCG suspended/SCG de-configured prior failure.

In some embodiments, the method further includes, upon identifying that the RLF defined in the received RLF Report occurred while fast MCG recovery was configured and while SCG was deactivated, optimizing the SCG deactivation feature by, e.g., one or more of:
Disabling SCG activation/deactivation for wireless devices 22 in same/similar conditions (e.g., coverage (area), location if available, etc.); and/or
Deactivating SCG for shorter periods for UEs in same conditions (e.g. coverage, location if available, etc.).

In some embodiments, a method performed at a third network node 16 at which a re-establishment attempt is made by the wireless device 22 or a fourth network node 16 at which the RLF Report was fetched is provided. Note that in some embodiments, the third network node 16 and the fourth network node 16 may be the same network node 16. The method includes receiving, from the wireless device 22, an indication that an RLF Report is ready to be fetched. The third network node 16/fourth network node 16 fetches the RLF Report from the wireless device 22, e.g., in response to the indication. Upon identifying that the RLF defined in the received RLF Report occurred while fast MCG recovery was configured and while SCG was deactivated, the third network node 16/fourth network node 16 sends the RLF Report to the first network node 16 and/or the second network node 16.

In some embodiments, the RLF Report may be sent via an XnAP message.

In some embodiments, the RLF Report may be contained in an XnAP Failure Indication message, where the message indicates that the RLF occurred while fast MCG recovery was configured but SCG was deactivated. This indication may be one or more of:
An initiating condition. e.g., Fast MCG Recovery Failure;
An IE, e.g., Fast MCG Recovery Failure; and/or
Included in the RLF Report itself.

### Example Implementation

The following is a non-limiting example of a possible standard implementation (for example implementation as part of 3GPP TS 38.423 V17.1.0) in accordance with the present disclosure, with the portion in hold corresponding to features of one or more embodiments of the present disclosure.

### “8.4.7 Failure Indication

### 8.4.7.1 General

A purpose of the Failure Indication procedure is to transfer information regarding RRC re-establishment attempts, or received RLF Reports, between NG-RAN nodes. The signaling takes place from the NG-RAN node at which a re-establishment attempt is made, or an RLF Report is received, to an NG-RAN node to which the UE concerned may have previously been attached prior to the connection failure. This may aid the detection of radio link failure, handover failure cases.

The procedure uses non UE-associated signaling.

### Successful Operation

NG-RAN node₂ initiates the procedure by sending the FAILURE INDICATION message to NG-RAN node₁, following a re-establishment attempt or an RLF Report reception from a UE or another RAN node at NG-RAN node₂, when NG-RAN node₂ considers that the UE may have previously suffered a connection failure at a cell controlled by NG-RAN node₁. NG-RAN node₂ may initiate the procedure toward the NG-RAN node, if the RLF report or the previously received Failure Indication message indicates that at the time of failure the SCG was deactivated. NG-RAN node₂ may send the Failure Indication message to the NG-RAN node₁ according to the PSCell ID provided in the RLF report.

If the UE RLF Report Container IE is included in the FAILURE INDICATION message, NG-RAN node₁ shall use it to derive failure case information.

### 8.4.7.3 Unsuccessful Operation

Not applicable.

### 8.4.7.4 Abnormal Conditions

Void.

### 9.1.3.16 Failure Indication

This message is sent by NG-RAN node₂ to indicate an RRC re-establishment attempt or a reception of an RLF Report from a UE that suffered a connection failure at NG-RAN node₁.

| | | | | |
|---|---|---|---|---|
| Direction: | | | | |
| NG-RAN node₂ −> | | | | |
| NG-RAN node₁. | | | IE type and | Semantics |
| IE/Group Name | Presence | Range | reference | description |

| | | | |
|---|---|---|---|
| Message Type | M | 9.2.3.1 | |
| CHOICE Initiating | M | | |
| condition | | | |
| >RRC Reestab | | | |
| >>CHOICE RRC | M | | |
| Reestab Initiated | | | |
| Reporting | | | |
| >>>RRC Reestab | | | |
| Reporting without | | | |
| RLF Report | | | |
| >>>>Failure cell | M | 9.2.2.10 | Physical Cell |
| PCI | | | Identifier |
| >>>>Re- | M | Global NG- | |
| establishment | | RAN Cell | |
| cell CGI | | Identity | |
| | | 9.2.2.27 | |
| >>>>C-RNTI | M | BIT STRING | C-RNTI |
| | | (SIZE (16)) | contained in |
| | | | the RRCRe- |
| | | | establishment |
| | | | Request |
| | | | message (TS |
| | | | 38.331 [10]) |
| | | | or in the |
| | | | RRCConnectionReestablishmentRequest |
| | | | message (TS |
| | | | 36.331 [14]) |
| >>>>ShortMAC-I | M | BIT STRING | ShortMAC-I |
| | | (SIZE (16)) | contained in |
| | | | the RRCRe- |
| | | | establishment |
| | | | Request |
| | | | message (TS |
| | | | 38.331 [10]) |
| | | | or in the |
| | | | RRCConnectionReestablishmentRequest |
| | | | message (TS |
| | | | 36.331 [14]) |
| >>>>SCG | O | ENUMERATED | This field |
| Deactivated | | (true, . . . ) | indicates that |
| | | | the SCG was |
| | | | deactivated at |
| | | | the time of |
| | | | fast MCG |
| | | | recovery |
| >>>RRC Reestab | | | |
| Reporting with | | | |
| RLF Report | | | |
| >>>>UE RLF | M | 9.2.2.59 | nr-RLF- |
| Report | | | Report-r16 IE |
| Container | | | contained in |
| | | | the |
| | | | UEInformationResponse |
| | | | message (TS |
| | | | 38.331 [10]) |
| | | | or RLF- |
| | | | Report-r9 IE |
| | | | contained in |
| | | | the |
| | | | UEInformationResponse |
| | | | message (TS |
| | | | 36.331 [14]) |
| >>>>SCG | O | ENUMERATED | This field |
| Deactivated | | (true, . . . ) | indicates that |
| | | | the SCG was |
| | | | deactivated at |
| | | | the time of |
| | | | fast MCG |
| | | | recovery |
| >RRC Setup | | | |
| >>CHOICE RRC | M | | |
| Setup Initiated | | | |
| Reporting | | | |
| >>>RRC Setup | | | |
| Reporting with | | | |
| RLF Report | | | |
| >>>>UE RLF | M | 9.2.2.59 | nr-RLF- |
| Report | | | Report-r16 IE |
| Container | | | contained in |
| | | | the |
| | | | UEInformationResponse |
| | | | message (TS |
| | | | 38.331 [10]) |
| | | | or RLF- |
| | | | Report-r9 IE |
| | | | contained in |
| | | | the |
| | | | UEInformationResponse |
| | | | message (TS |
| | | | 36.331 [14]) |
| >>>>SCG | O | ENUMERATED | This field |
| Deactivated | | (true, . . . ) | indicates that |
| | | | the SCG was |
| | | | deactivated at |
| | | | the time of |
| | | | fast MCG |
| | | | recovery |

In another non-limiting example of a standard implementation of embodiments of the present disclosure based on the 3GPP TS 38.423, with features of embodiments of the present disclosure emphasized in bold below:

### 9.1.3.16 Failure Indication

This message is sent by NG-RAN node₂ to indicate an RRC re-establishment attempt or a reception of an RLF Report from a UE that suffered a connection failure at NG-RAN node₁.

Direction: NG-RAN node₂->NG-RAN node₁.

| | | | | |
|---|---|---|---|---|
| | | | IE type and | Semantics |
| IE/Group Name | Presence | Range | reference | description |

| | | | |
|---|---|---|---|
| Message Type | M | 9.2.3.1 | |
| CHOICE Initiating | M | | |
| condition | | | |
| >RRC Reestab | | | |
| >>CHOICE RRC | M | | |
| Reestab Initiated | | | |
| Reporting | | | |
| >>>RRC Reestab | | | |
| Reporting without | | | |
| RLF Report | | | |
| >>>>Failure cell | M | 9.2.2.10 | Physical Cell |
| PCI | | | Identifier |
| >>>>Re- | M | Global NG- | |
| establishment | | RAN Cell | |
| cell CGI | | Identity | |
| | | 9.2.2.27 | |
| >>>>C-RNTI | M | BIT STRING | C-RNTI |
| | | (SIZE (16)) | contained in |
| | | | the RRCRe- |
| | | | establishment |
| | | | Request |
| | | | message (TS |
| | | | 38.331 [10]) |
| | | | or in the |
| | | | RRCConnectionReestablishmentRequest |
| | | | message (TS |
| | | | 36.331 [14]) |
| >>>>ShortMAC-I | M | BIT STRING | ShortMAC-I |
| | | (SIZE (16)) | contained in |
| | | | the RRCRe- |
| | | | establishment |
| | | | Request |
| | | | message (TS |
| | | | 38.331 [10]) |
| | | | or in the |
| | | | RRCConnectionReestablishmentRequest |
| | | | message (TS |
| | | | 36.331 [14]) |
| >>>>SCG | O | ENUMERATED | This field |
| status | | (deactivated, | indicates the |
| | | suspended, de- | status of the |
| | | configured/failed) | SCG at the |
| | | | time of MCG |
| | | | failure or at |
| | | | the time of |
| | | | fast MCG link |
| | | | recovery |
| >>>RRC Reestab | | | |
| Reporting with | | | |
| RLF Report | | | |
| >>>>UE RLF | M | 9.2.2.59 | nr-RLF- |
| Report | | | Report-r16 IE |
| Container | | | contained in |
| | | | the |
| | | | UEInformationResponse |
| | | | message (TS |
| | | | 38.331 [10]) |
| | | | or RLF- |
| | | | Report-r9 IE |
| | | | contained in |
| | | | the |
| | | | UEInformationResponse |
| | | | message (TS |
| | | | 36.331 [14]) |
| >>>>SCG | O | ENUMERATED | This field |
| status | | (deactivated, | indicates the |
| | | suspended, de- | status of the |
| | | configured/failed) | SCG at the |
| | | | time of MCG |
| | | | failure or at |
| | | | the time of |
| | | | fast MCG link |
| | | | recovery |
| >RRC Setup | | | |
| >>CHOICE RRC | M | | |
| Setup Initiated | | | |
| Reporting | | | |
| >>>RRC Setup | | | |
| Reporting with | | | |
| RLF Report | | | |
| >>>>UE RLF | M | 9.2.2.59 | nr-RLF- |
| Report | | | Report-r16 IE |
| Container | | | contained in |
| | | | the |
| | | | UEInformationResponse |
| | | | message (TS |
| | | | 38.331 [10]) |
| | | | or RLF- |
| | | | Report-r9 IE |
| | | | contained in |
| | | | the |
| | | | UEInformationResponse |
| | | | message (TS |
| | | | 36.331 [14]) |
| >>>>SCG | O | ENUMERATED | This field |
| status | | (deactivated, | indicates the |
| | | suspended, de- | status of the |
| | | configured/ | SCG at the |
| | | failed) | time of MCG |
| | | | failure or at |
| | | | the time of |
| | | | fast MCG link |
| | | | recovery |

In another non-limiting example implementation, the above embodiment(s) may be implemented as part of a Handover Report procedure, for example, in 3GPP TS 38.423 V17.1.0.

In yet another non-limiting example implementation, the above embodiment(s) may be implemented in the following way, e.g., based on the 3GPP TS 38.423 V 17.1.0.

### 9.1.3.16 Failure Indication

This message is sent by NG-RAN node₂ to indicate an RRC re-establishment attempt or a reception of an RLF Report from a UE that suffered a connection failure at NG-RAN node₁.

Direction: NG-RAN node₂->NG-RAN node₁.

| | | | | |
|---|---|---|---|---|
| | | | IE type and | Semantics |
| IE/Group Name | Presence | Range | reference | description |

| | | | |
|---|---|---|---|
| Message Type | M | 9.2.3.1 | |
| CHOICE Initiating | M | | |
| condition | | | |
| >RRC Reestab | | | |
| >>CHOICE RRC | M | | |
| Reestab Initiated | | | |
| Reporting | | | |
| >>>RRC Reestab | | | |
| Reporting without | | | |
| RLF Report | | | |
| >>>>Failure cell | M | 9.2.2.10 | Physical Cell |
| PCI | | | Identifier |
| >>>>Re- | M | Global NG- | |
| establishment | | RAN Cell | |
| cell CGI | | Identity | |
| | | 9.2.2.27 | |
| >>>>C-RNTI | M | BIT STRING | C-RNTI |
| | | (SIZE (16)) | contained in |
| | | | the RRCRe- |
| | | | establishment |
| | | | Request |
| | | | message (TS |
| | | | 38.331 [10]) |
| | | | or in the |
| | | | RRCConnectionReestablishmentRequest |
| | | | message (TS |
| | | | 36.331 [14]) |
| >>>>ShortMAC-I | M | BIT STRING | ShortMAC-I |
| | | (SIZE (16)) | contained in |
| | | | the RRCRe- |
| | | | establishment |
| | | | Request |
| | | | message (TS |
| | | | 38.331 [10]) |
| | | | or in the |
| | | | RRCConnectionReestablishmentRequest |
| | | | message (TS |
| | | | 36.331 [14]) |
| >>>RRC Reestab | | | |
| Reporting with | | | |
| RLF Report | | | |
| >>>>UE RLF | M | 9.2.2.59 | nr-RLF- |
| Report | | | Report-r16 IE |
| Container | | | contained in |
| | | | the |
| | | | UEInformationResponse |
| | | | message (TS |
| | | | 38.331 [10]) |
| | | | or RLF- |
| | | | Report-r9 IE |
| | | | contained in |
| | | | the |
| | | | UEInformationResponse |
| | | | message (TS |
| | | | 36.331 [14]) |
| >RRC Setup | | | |
| >>CHOICE RRC | M | | |
| Setup Initiated | | | |
| Reporting | | | |
| >>>RRC Setup | | | |
| Reporting with | | | |
| RLF Report | | | |
| >>>>UE RLF | M | 9.2.2.59 | nr-RLF- |
| Report | | | Report-r16 IE |
| Container | | | contained in |
| | | | the |
| | | | UEInformationResponse |
| | | | message (TS |
| | | | 38.331 [10]) |
| | | | or RLF- |
| | | | Report-r9 IE |
| | | | contained in |
| | | | the |
| | | | UEInformationResponse |
| | | | message (TS |
| | | | 36.331 [14]) |
| >Fast MCG | | | |
| Recovery failure | | | |
| >>SCG | O | ENUMERATED | This field |
| Deactivated | | (true, . . . ) | indicates that |
| | | | the SCG was |
| | | | deactivated at |
| | | | the time of |
| | | | fast MCG |
| | | | recovery |
| >>SCG status | O | ENUMERATED | This field |
| | | (deactivated, | |
| | | suspended, de- | indicates the |
| | | configured/failed) | status of the |
| | | | SCG at the |
| | | | time of MCG |
| | | | failure or at |
| | | | the time of |
| | | | fast MCG link |
| | | | recovery |

The following is a nonlimiting list of example embodiments.

1. A first network node configured to communicate with a wireless device and a second network node, the wireless device being configured with a dual connectivity (DC) configuration including a master node (MN) and a secondary node (SN), the first network node being the MN of the DC configuration, the second network node being the SN of the DC configuration, the first network node configured to, and/or comprising a radio interface and/or comprising processing circuitry configured to:
configure the wireless device with a fast master cell group (MCG) recovery configuration in case of radio link failure (RLF) in the MCG;
configure the wireless device with the second network node operating as the SN to allow SCG activation/deactivation;
determine that the wireless device has lost connectivity with the MN;
optionally, receive a message from a third network node at which a re-establishment attempt was made by the wireless device in response to the RLF;
receive an RLF Report from at least one of:
   the third network node; and
   a fourth network node at which the RLF Report was fetched; and
perform at least one network node action based on the receiving of the RLF Report.

2. The first network node of Example 1, wherein the RLF Report is received via at least one Xn Application Protocol (XnAP) message.

3. The first network node of Example 2, wherein the at least one XnAP message includes an XnAP Failure Indication message, the XnAP Failure Indication message indicating that:
the RLF occurred while fast MCG recovery was configured; and
the SCG was at least one of:
   deactivated;
   suspended;
   de-configured; and
optionally, the indication being at least one of:
   an initiating condition;
   an information element (IE);
   included in the RLF Report; and
   an SCG status at the time of the MCG recovery.

4. The first network node of any one of Examples 1-3, wherein performing of the at least one network node action includes forward the RLF Report to the second network node based on identifying that the RLF defined in the received RLF Report occurred while fast MCG recovery was configured and while the SCG was at least one of deactivated, suspended, and de-configured.

5. The first network node of any one of Examples 1-4, wherein the performing of the at least one network node action includes optimizing and/or modifying the combination of Fast MCG recovery and SCG deactivation features based on a determination that the RLF defined in the received RLF Report occurred while fast MCG recovery was configured and while SCG was deactivated, the optimizing and/or modifying including at least one of:
prohibiting the SN from enabling the SCG activation/deactivation;
optimizing the SCG activation/deactivation criterion and/or policies;
optimizing the SCG addition/Primary Secondary Cell (PSCell) change policies;
informing the SN that fast MCG is configured; and
disabling SCG activation/deactivation when radio conditions are getting worse.

6. A method implemented in a first network node configured to communicate with a wireless device and a second network node, the wireless device being configured with a dual connectivity (DC) configuration including a master node (MN) and a secondary node (SN), the first network node being the MN of the DC configuration, the second network node being the SN of the DC configuration, the method comprising:
configuring the wireless device with a fast master cell group (MCG) recovery configuration in case of radio link failure (RLF) in the MCG;
configuring the wireless device with the second network node operating as the SN to allow SCG activation/deactivation;
determining that the wireless device has lost connectivity with the MN;
optionally, receiving a message from a third network node at which a re-establishment attempt was made by the wireless device in response to the RLF;
receiving an RLF Report from at least one of:
   the third network node; and
   a fourth network node at which the RLF Report was fetched; and
performing at least one network node action based on the receiving of the RLF Report.

7. The method of Example 6, wherein the RLF Report is received via at least one Xn Application Protocol (XnAP) message.

8. The method of Example 7, wherein the at least one XnAP message includes an XnAP Failure Indication message, the XnAP Failure Indication message indicating that:
the RLF occurred while fast MCG recovery was configured; and
the SCG was at least one of:
   deactivated;
   suspended;
   de-configured; and
optionally, the indication being at least one of:
   an initiating condition;
   an information element (IE);
   included in the RLF Report; and
   an SCG status at the time of the MCG recovery.

9. The method of any one of Examples 6-8, wherein the performing of the at least one network node action includes forwarding the RLF Report to the second network node based on identifying that the RLF defined in the received RLF Report occurred while fast MCG recovery was configured and while the SCG was at least one of deactivated, suspended, and de-configured.

10. The method of any one of Examples 6-9, wherein the performing of the at least one network node action includes optimizing and/or modifying the combination of Fast MCG recovery and SCG deactivation features based on a determination that the RLF defined in the received RLF Report occurred while fast MCG recovery was configured and while SCG was deactivated, the optimizing and/or modifying including at least one of:
prohibiting the SN from enabling the SCG activation/deactivation;
optimizing the SCG activation/deactivation criterion and/or policies;
optimizing the SCG addition/Primary Secondary Cell (PSCell) change policies;
informing the SN that fast MCG is configured; and
disabling SCG activation/deactivation when radio conditions are getting worse.

11. A second network node configured to communicate with a wireless device and a first network node, the wireless device being configured with a dual connectivity (DC) configuration including a master node (MN) and a secondary node (SN), the first network node being the MN of the DC configuration, the second network node being the SN of the DC configuration, the second network node configured to, and/or comprising a radio interface and/or comprising processing circuitry configured to:
receive from the MN a configuration to allow secondary cell group (SCG) activation/deactivation;
deactivate the SCG based on at least one network condition;
determine a loss of connectivity with the wireless device, the wireless device having declared RLF in the MCG;
receive an RLF report from at least one of:
   the MN;
   a third network node at which a re-establishment attempt was made by the wireless device; and
   a fourth network node at which the RLF Report was fetched; and
perform at least one network node action based on at least one of the receiving of the RLF Report and the determining of the loss of connectivity with the wireless device.

12. The second network node of Example 11, wherein the wireless device is configured with a fast master cell group (MCG) recovery configuration in case of radio link failure (RLF) in the MCG.

13. The second network node of any one of Examples 11 and 12, the RLF Report is received via at least one Xn Application Protocol (XnAP) message.

14. The second network node of Example 13, wherein the at least one XnAP message includes an XnAP Failure Indication message, the XnAP Failure Indication message indicating that:
the RLF occurred while fast MCG recovery was configured;
the SCG was deactivated; and
optionally, the indication being at least one of:
   an initiating condition;
   an information element (JE); and
   included in the RLF Report.

15. The second network node of any one of Examples 11-14, wherein the performing of the at least one network node action includes optimizing and/or modifying the SCG deactivation feature based on determining that the RLF defined in the received RLF Report occurred while fast MCG recovery was configured and while SCG was deactivated, the optimizing and/or modifying including at least one of:
disabling SCG activation/deactivation for wireless devices in similar network conditions; and
deactivating SCG for shorter periods for wireless devices in similar network conditions.

16. A method implemented in a second network node configured to communicate with a wireless device and a first network node, the wireless device being configured with a dual connectivity (DC) configuration including a master node (MN) and a secondary node (SN), the first network node being the MN of the DC configuration, the second network node being the SN of the DC configuration, the method comprising:
receiving from the MN a configuration to allow secondary cell group (SCG) activation/deactivation;
deactivating the SCG based on at least one network condition;
determining a loss of connectivity with the wireless device, the wireless device having declared RLF in the MCG; and
receiving an RLF report from at least one of:
   the MN;
   a third network node at which a re-establishment attempt was made by the wireless device; and
   a fourth network node at which the RLF Report was fetched; and
performing at least one network node action based on at least one of the receiving of the RLF Report and the determining of the loss of connectivity with the wireless device.

17. The method of Example 16, wherein the wireless device is configured with a fast master cell group (MCG) recovery configuration in case of radio link failure (RLF) in the MCG.

18. The method of any one of Examples 16 and 17, the RLF Report is received via at least one Xn Application Protocol (XnAP) message.

19. The method of Example 18, wherein the at least one XnAP message includes an XnAP Failure Indication message, the XnAP Failure Indication message indicating that:
the RLF occurred while fast MCG recovery was configured;
the SCG was deactivated; and
optionally, the indication being at least one of:
   an initiating condition;
   an information element (IE); and
   included in the RLF Report.

20. The method of any one of Examples 16-19, wherein the performing of the at least one network node action includes optimizing and/or modifying the SCG deactivation feature based on determining that the RLF defined in the received RLF Report occurred while fast MCG recovery was configured and while SCG was deactivated, the optimizing and/or modifying including at least one of:
disabling SCG activation/deactivation for wireless devices in similar network conditions; and
deactivating SCG for shorter periods for wireless devices in similar network conditions.

21. A second network node configured to communicate with a wireless device and a first network node, the wireless device being configured with a dual connectivity (DC) configuration including a master node (MN) and a secondary node (SN), the first network node being the MN of the DC configuration, the second network node being the SN of the DC configuration, the second network node configured to, and/or comprising a radio interface and/or comprising processing circuitry configured to:
determine a loss of connectivity with the wireless device, the wireless device having declared RLF in the MCG and RLF in the SCG;
receive an RLF report from at least one of:
   the MN;
   a third network node at which a re-establishment attempt was made by the wireless device; and
   a fourth network node at which the RLF Report was fetched; and
perform at least one network node action based on at least one of the receiving of the RLF Report and the determining of the loss of connectivity with the wireless device.

22. The second network node of Example 21, wherein the wireless device is configured with a fast master cell group (MCG) recovery configuration in case of radio link failure (RLF) in the MCG.

23. The second network node of any one of Examples 21 and 22, the RLF Report is received via at least one Xn Application Protocol (XnAP) message.

24. The second network node of Example 23, wherein the at least one XnAP message includes an XnAP Failure Indication message, the XnAP Failure Indication message indicating that:
the RLF occurred while fast MCG recovery was configured;
the SCG was deactivated; and
optionally, the indication being at least one of:
   an initiating condition;
   an information element (IE);
   included in the RLF Report; and
   an SCG status at the time of the MCG recovery.

25. The second network node of any one of Examples 21-24, wherein the performing of the at least one network node action includes optimizing and/or modifying the SCG deactivation feature based on determining that the RLF defined in the received RLF Report occurred while fast MCG recovery was configured and while SCG was deactivated, the optimizing and/or modifying including at least one of:
disabling SCG activation/deactivation for wireless devices in similar network conditions; and
deactivating SCG for shorter periods for wireless devices in similar network conditions.

26. A method implemented in a second network node configured to communicate with a wireless device and a first network node, the wireless device being configured with a dual connectivity (DC) configuration including a master node (MN) and a secondary node (SN), the first network node being the MN of the DC configuration, the second network node being the SN of the DC configuration, the second network node configured to, and/or comprising a radio interface and/or comprising processing circuitry configured to:
determining a loss of connectivity with the wireless device, the wireless device having declared RLF in the MCG and RLF in the SCG;
receiving an RLF report from at least one of:
   the MN; and
   a third network node at which a re-establishment attempt was made by the wireless device; and
   a fourth network node at which the RLF Report was fetched; and
performing at least one network node action based on at least one of the receiving of the RLF Report and the determining of the loss of connectivity with the wireless device.

27. The method of Example 26, wherein the wireless device is configured with a fast master cell group (MCG) recovery configuration in case of radio link failure (RLF) in the MCG.

28. The method of any one of Examples 26 and 27, the RLF Report is received via at least one Xn Application Protocol (XnAP) message.

29. The method of Example 28, wherein the at least one XnAP message includes an XnAP Failure Indication message, the XnAP Failure Indication message indicating that:
the RLF occurred while fast MCG recovery was configured;
the SCG was deactivated; and
optionally. the indication being at least one of:
   an initiating condition;
   an information element (IE);
   included in the RLF Report; and
   an SCG status at the time of the MCG recovery.

30. The method of any one of Examples 26-29, wherein the performing of the at least one network node action includes optimizing and/or modifying the SCG deactivation feature based on determining that the RLF defined in the received RLF Report occurred while fast MCG recovery was configured and while SCG was deactivated, the optimizing and/or modifying including at least one of:
disabling SCG activation/deactivation for wireless devices in similar network conditions; and
deactivating SCG for shorter periods for wireless devices in similar network conditions.

31. A third network node configured to communicate with a wireless device in a wireless communication network including a first network node and a second network node, the wireless device being configured with a dual connectivity (DC) configuration including a master node (MN) and a secondary node (SN), the first network node being the MN of the DC configuration, the second network node being the SN of the DC configuration, the third network node configured to, and/or comprising a radio interface and/or comprising processing circuitry configured to:
receive a first indication from the wireless device that a radio link failure (RLF) Report is ready to be fetched;
cause transmission of a second indication to the wireless device to transmit the RLF Report to the third network node in response to the first indication;
receive the RLF Report from the wireless device in response to the transmission of the second indication;
determine that the RLF defined in the received RLF Report occurred while fast MCG recovery was configured and while SCG was deactivated; and
cause transmission of an RLF report to at least one of the first network node and the second network node based on the determination.

32. The third network node of Examples 31, wherein the wireless device is configured with a fast master cell group (MCG) recovery configuration in case of radio link failure (RLF) in the MCG.

33. The third network node of any one of Examples 31 and 32, the RLF Report is received via at least one Xn Application Protocol (XnAP) message.

34. The third network node of Example 33, wherein the at least one XnAP message includes an XnAP Failure Indication message, the XnAP Failure Indication message indicating that:
the RLF occurred while fast MCG recovery was configured;
the SCG was deactivated; and
optionally. the indication being at least one of:
   an initiating condition;
   an information element (IE); and
   included in the RLF Report.

35. The third network node of any one of Examples 31-34, wherein the processing circuitry is further configured to determine that the wireless device has made a re-establishment attempt with the third network node; and
the causing transmission of the RLF report to the at least one of the first network node and the second network node being further based on the determination that the wireless device has made the re-establishment attempt.

36. A method implemented in a third network node configured to communicate with a wireless device in a wireless communication network including a first network node and a second network node, the wireless device being configured with a dual connectivity (DC) configuration including a master node (MN) and a secondary node (SN), the first network node being the MN of the DC configuration, the second network node being the SN of the DC configuration, the method comprising:
receiving a first indication from the wireless device that a radio link failure (RLF) Report is ready to be fetched;
causing transmission of a second indication to the wireless device to transmit the RLF Report to the third network node in response to the first indication;
receiving the RLF Report from the wireless device in response to the transmission of the second indication;
determining that the RLF defined in the received RLF Report occurred while fast MCG recovery was configured and while SCG was deactivated; and
causing transmission of an RLF report to at least one of the first network node and the second network node based on the determination.

37. The method of Example 36, wherein the wireless device is configured with a fast master cell group (MCG) recovery configuration in case of radio link failure (RLF) in the MCG.

38. The method of any one of Examples 36 and 37, wherein the RLF Report is received via at least one Xn Application Protocol (XnAP) message.

39. The method of Examples 38, wherein the at least one XnAP message includes an XnAP Failure Indication message, the XnAP Failure Indication message indicating that:
the RLF occurred while fast MCG recovery was configured;
the SCG was deactivated; and
optionally, the indication being at least one of:
   an initiating condition;
   an information element (IE); and
   included in the RLF Report.

40. The method of any one of Examples 36-39, wherein the processing circuitry is further configured to determine that the wireless device has made a re-establishment attempt with the third network node; and
the causing transmission of the RLF report to the at least one of the first network node and the second network node being further based on the determination that the wireless device has made the re-establishment attempt.

41. A wireless device configured to communicate with a first network node in a wireless communication network including a second network node and a third network node, the wireless device being configured with a dual connectivity (DC) configuration including a master node (MN) and a secondary node (SN), the first network node being the MN of the DC configuration, the second network node being the SN of the DC configuration, the WD configured to, and/or comprising a radio interface and/or processing circuitry configured to:
determine a radio link failure (RLF);
determine a RLF Report based on the determined RLF;
cause transmission of a first indication to the third network node that the RLF Report is ready to be fetched;
receive a second indication from the third network node to transmit the RLF Report to the third network node in response to the first indication; and
cause transmission of the RLF Report to the third network node in response to the transmission of the second indication, the RLF report being forwarded to at least one of the first network node and the second network node based on a determination that the RLF defined in the received RLF Report occurred while fast Master Cell Group (MCG) recovery was configured and while SCG was deactivated.

42. The wireless device of Example 41, wherein the processing circuitry is further configured to:
perform a re-establishment attempt with the third network node, the forwarding of the RLF report to the at least one of the first network node and the second network node being based on the wireless device performing the re-establishment attempt.

43. A method implemented in a wireless device configured to communicate with a first network node in a wireless communication network including a second network node and a third network node, the wireless device being configured with a dual connectivity (DC) configuration including a master node (MN) and a secondary node (SN), the first network node being the MN of the DC configuration, the second network node being the SN of the DC configuration, the method comprising:
determining a radio link failure (RLF);
determining a RLF Report based on the determined RLF;
causing transmission of a first indication to the third network node that the RLF Report is ready to be fetched;
receiving a second indication from the third network node to transmit the RLF Report to the third network node in response to the first indication; and
causing transmission of the RLF Report to the third network node in response to the transmission of the second indication, the RLF report being forwarded to at least one of the first network node and the second network node based on a determination that the RLF defined in the received RLF Report occurred while fast Master Cell Group (MCG) recovery was configured and while SCG was deactivated.

44. The method of Example 43, further comprising:
performing a re-establishment attempt with the third network node, the forwarding of the RLF report to the at least one of the first network node and the second network node being based on the wireless device performing the re-establishment attempt.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| MN | Master Node |
| SN | Secondary Node |
| PCell | Primary Cell |
| PSCell | Primary Secondary Cell |
| RAN | Radio Access Network |
| RLF | Radio Link Failure |
| UE | User Equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first network node configured to communicate with a wireless device, WD, a second network node, a third network node, and a fourth network node, the WD being configured with a dual connectivity, DC, configuration including at least one parameter usable to communicate with a master node, MN, and a secondary node, SN, the first network node being the MN of the DC configuration and associated with a master cell group, MCG, the second network node being the SN of the DC configuration and associated with a secondary cell group, SCG, the second network node and the third network node being different nodes the first network node configured to:
determine that the WD has lost connectivity with the MN, the WD having declared a radio link failure, RLF, in the MCG;
receive an RLF Report from one or both of:
the third network node at which a communication re-establishment attempt was made by the WD in response to the RLF; and
the fourth network node at which the RLF Report was fetched; and
upon identifying the RLF report comprises information about the RLF occurring while a fast MCG recovery was configured and the SCG had an SCG status, forward the RLF report to the SN including information about a fast MCG recovery failure.

2. The first network node of claim 1, wherein the RLF Report is received via an Xn Application Protocol, XnAP, message.

3. The first network node of claim 2, wherein the XnAP message includes an XnAP Failure Indication message, the XnAP Failure Indication message comprising an indication indicating one or both of:
the RLF occurred while the fast MCG recovery was configured; and
the SCG status.

4. The first network node of claim 3, wherein the indication is one or more of:
an initiating condition associated with the fast MCG recovery failure;
an information element, IE, associated with the fast MCG recovery failure;
included in the RLF Report; and
the SCG status at the time of the MCG recovery.

5. The first network node of claim 1, wherein:
the SCG status is one or more of:
deactivated;
suspended; and
de-configured; and
the first network node is further configured to:
upon identifying that the RLF report comprises information about the RLF occurring while a fast MCG recovery was configured and the SCG status is deactivated, optimize one or both of the fast MCG recovery and a SCG deactivation process.

6. (canceled)

7. The first network node of claim 5, wherein optimizing the one or both the fast MCG recovery and the SCG deactivation process includes one or more of:
preventing the SN from enabling SCG activation or SCG deactivation;
optimizing SCG activation and deactivation policies;
optimizing SCG addition;
optimizing primary secondary cell, PSCell, change policies;
informing the SN that the fast MCG recovery is configured; and
disabling one or both of the SCG activation and the SCG deactivation when radio conditions are below a predetermined threshold.

8. The first network node of claim 1, wherein the first network node is further configured to:
configure the WD with a fast master cell group, MCG, recovery configuration usable for responding to the RLF in the MCG; and
configure the WD with the second network node operating as the SN to allow one or both of an SCG activation and an SCG deactivation.

9. The first network node of claim 1, wherein the third network node is an access node configured to communicate with the WD and the first network node.

10. The first network node of claim 1, wherein the RLF occurred in a first cell of the MCG, and the first network node is further configured to:
receive the RLF Report from the WD via a second cell different from the first cell.

11. A method in a first network node configured to communicate with a wireless device, WD, a second network node, a third network node, and a fourth network node, the WD being configured with a dual connectivity, DC, configuration including at least one parameter usable to communicate with a master node, MN, and a secondary node, SN, the first network node being the MN of the DC configuration and associated with a master cell group, MCG, the second network node being the SN of the DC configuration and associated with a secondary cell group, SCG, the second network node and the third network node being different nodes the method comprising:
determining that the WD has lost connectivity with the MN, the WD having declared a radio link failure, RLF, in the MCG;
receiving an RLF Report from one or both of:
the third network node at which a communication re-establishment attempt was made by the WD in response to the RLF; and
the fourth network node at which the RLF Report was fetched; and
upon identifying the RLF report comprises information about the RLF occurring while a fast MCG recovery was configured and the SCG had an SCG status, forwarding the RLF report to the SN including information about a fast MCG recovery failure.

12. The method of claim 11, wherein the RLF Report is received via an Xn Application Protocol, XnAP, message.

13. The method of claim 12, wherein the XnAP message includes an XnAP Failure Indication message, the XnAP Failure Indication message comprising an indication indicating one or both of:
the RLF occurred while the fast MCG recovery was configured; and
the SCG status.

14. The method of claim 13, wherein the indication is one or more of:
an initiating condition associated with the fast MCG recovery failure;
an information element, IE, associated with the fast MCG recovery failure;
included in the RLF Report; and
the SCG status at the time of the MCG recovery.

15. The method of claim 11, wherein:
the SCG status is one or more of:
deactivated;
suspended; and
de-configured, and
upon identifying the RLF report comprises information about the RLF occurring while a fast MCG recovery was configured and the SCG status is deactivated, optimizing one or both of the fast MCG recovery and a SCG deactivation process.

16. (canceled)

17. The method of claim 15, wherein optimizing the one or both the fast MCG recovery and the SCG deactivation process includes one or more of:
preventing the SN from enabling SCG activation or SCG deactivation;
optimizing SCG activation and deactivation policies;
optimizing SCG addition;
optimizing primary secondary cell, PSCell, change policies;
informing the SN that the fast MCG recovery is configured; and
disabling one or both of the SCG activation and the SCG deactivation when radio conditions are below a predetermined threshold.

18. The method of claim 11, wherein the method further includes:
configuring the WD with an MCG recovery configuration usable for responding to the RLF in the MCG; and
configuring the WD with the second network node operating as the SN to allow one or both of an SCG activation and an SCG deactivation.

19. The method of claim 11, wherein the third network node is an access node configured to communicate with the WD and the first network node.

20. The method of claim 11, wherein the RLF occurred in a first cell of the MCG, and the method further includes:
receiving the RLF Report from the WD via a second cell different from the first cell.

21. A second network node configured to communicate with a wireless device, WD, a first network node, and a third network node, the WD being configured with a dual connectivity, DC, configuration including at least one parameter usable to communicate with a master node, MN, and a secondary node, SN, the first network node being the MN of the DC configuration and associated with a master cell group, MCG, the second network node being the SN of the DC configuration and associated with a secondary cell group, SCG, the second network node and the third network node being different nodes the second network node configured to:
receive a radio link failure, RLF, Report from one or both of:
the first network node, the WD having lost connectivity with the first network node and declared the RLF in the MCG; and
the third network node at which a communication re-establishment attempt was made by the WD in response to the RLF, the RLF report including information about a fast MCG recovery failure; and
upon identifying the RLF report comprises information about the RLF occurring while a fast MCG recovery was configured and the SCG had an SCG status, optimize an SCG process.

22.-30. (canceled)

31. A method in a second network node configured to communicate with a wireless device, WD, a first network node, and a third network node, the WD being configured with a dual connectivity, DC, configuration including at least one parameter usable to communicate with a master node, MN, and a secondary node, SN, the first network node being the MN of the DC configuration and associated with a master cell group, MCG, the second network node being the SN of the DC configuration and associated with a secondary cell group, SCG, the second network node and the third network node being different nodes the method comprising:
receiving a radio link failure, RLF, Report from one or both of:
the first network node, the WD having lost connectivity with the first network node and declared the RLF in the MCG; and
the third network node at which a communication re-establishment attempt was made by the WD in response to the RLF, the RLF report including information about a fast MCG recovery failure; and
upon identifying the RLF report comprises information about the RLF occurring while a fast MCG recovery was configured and the SCG had an SCG status, optimizing an SCG process.

32.-40. (canceled)
